(19) United States
(12) Patent Application Publication
(10) Pub. No.: US 2019/0168492 A1
(43) Pub. Date: Jun. 6, 2019

(54) GAS BARRIER FILM AND METHOD OF PRODUCING GAS BARRIER FILM

(71) Applicant: FUJIFILM Corporation, Tokyo (JP)

(72) Inventor: Eijiro IWASE, Ashigara-kami-gun (JP)

(73) Assignee: FUJIFILM Corporation, Tokyo (JP)

(21) Appl. No.: 16/256,892

(22) Filed: Jan. 24, 2019

Related U.S. Application Data
(63) Continuation of application No. PCT/JP2017/029760, filed on Aug. 21, 2017.

(30) Foreign Application Priority Data
Aug. 31, 2016 (JP) 2016-169005

(51) Int. Cl. B32B 27/30; B32B 27/08; B32B 9/00

(52) U.S. Cl. CPC B32B 27/30; B32B 9/00; B32B 27/08

(57) ABSTRACT

The present invention provides a gas barrier film of an organic-inorganic lamination type having good adhesiveness between an organic layer disposed between inorganic layers and a lower inorganic layer thereof, and a method of producing the gas barrier film. A gas barrier film having two or more combinations of an organic layer and an inorganic layer on one surface of a support, in which a surface of the support is the organic layer, an organic layer on the surface of the support is an underlying organic layer, an organic layer between the inorganic layers is an intermediate organic layer, a thickness of the intermediate organic layer is 0.05 to 0.5 μm, a ratio between the thickness of the intermediate organic layer and a thickness of the underlying organic layer is 0.1 or less, and the intermediate organic layer includes a polymer of (meth)acrylate represented by Formula (1).

### CROSS-REFERENCE TO RELATED APPLICATIONS

This application is a Continuation of PCT International Application No. PCT/JP2017/029760 filed on Aug. 21, 2017, which claims priority under 35 U.S.C. § 119(a) to Japanese Patent Application No. 2016-169005 filed on Aug. 31, 2016. The above application is hereby expressly incorporated by reference, in its entirety, into the present application.

### BACKGROUND OF THE INVENTION

### 1. Field of the Invention

The present invention relates to a lamination type gas barrier film, and a method of producing the gas barrier film.

### 2. Description of the Related Art

A gas barrier film that blocks moisture, oxygen, and the like is used for protection of various members, materials, and the like.

For example, in recent years, in a display device using an organic electroluminescent element (organic EL element), a plastic liquid crystal, or the like, sealing of the organic EL element or the plastic liquid crystal with a gas barrier film has been performed to protect the organic EL element or the plastic liquid crystal.

In addition, in a solar cell, since a solar cell having a photoelectric conversion layer or the like is weak against moisture, sealing of the solar cell with a gas barrier film has been performed.

A gas barrier film usually has a constitution in which a resin film or the like is used as a support and a gas barrier layer that exhibits gas barrier properties is formed on the surface thereof.

In addition, there is known an organic-inorganic lamination type gas barrier film having one or more combinations of an inorganic layer as a gas barrier layer, and an organic layer, which becomes an underlayer of the inorganic layer, on a support, as a constitution which exhibits high gas barrier properties.

In the organic-inorganic lamination type gas barrier film, the inorganic layer which exhibits gas barrier properties is formed on the organic layer which becomes an underlying base. Thus, it is possible to remove regions in which an inorganic compound which becomes the inorganic layer is not easily deposited, such as unevenness and shadows of foreign substances, on the surface on which the inorganic layer is formed, and thus an appropriate inorganic layer can be formed over the entire surface of a substrate without gaps. As a result, the organic-inorganic lamination type gas barrier film exhibits high gas barrier properties.

For example, JP2015-044393A discloses a gas barrier film of such an organic-inorganic lamination type gas barrier film which has excellent gas barrier properties and improved adhesiveness between an inorganic layer and an organic layer formed on the inorganic layer since the organic layer formed on the inorganic layer contains a silane coupling agent having no radical polymerizable group.

### SUMMARY OF THE INVENTION

In an organic-inorganic lamination type gas barrier film, it is required to have good adhesiveness between an organic layer and an inorganic layer.

As described above, in JP2015-044393A, since the organic layer formed on the inorganic layer contains a specific silane coupling agent, adhesiveness between the inorganic layer and the organic layer formed on the inorganic layer is improved.

On the other hand, as described JP2015-044393A, in the organic-inorganic lamination type gas barrier film, as the number of combinations of an organic layer which becomes an underlying base and an inorganic layer increases, higher gas barrier properties are obtained.

Accordingly, for example, in a case where the organic-inorganic lamination type gas barrier film is used for applications requiring high gas barrier properties like organic EL elements, a gas barrier film having two or more combinations of an organic layer which becomes an underlying base and an inorganic layer is suitably used.

In the organic-inorganic lamination type gas barrier film having two or more combinations of an organic layer which becomes an underlying base and an inorganic layer, the organic layer which is formed between the inorganic layers, that is, the organic layer sandwiched between the inorganic layers is present.

However, according to the studies of the present inventors, the organic layer which is formed between the inorganic layers tends to have particularly low adhesiveness with the inorganic layer which becomes an underlayer, compared to other organic layers. Therefore, in some cases, it is not always possible to obtain sufficient adhesiveness with the lower inorganic layer only by incorporating a component for improving adhesiveness such as a silane coupling agent in the organic layer which is formed between the inorganic layers.

An object of the present invention is to solve such problems in the related art and to provide a gas barrier film of an organic-inorganic lamination type having high gas barrier properties and having good adhesiveness between an organic layer disposed between inorganic layers and a lower inorganic layer thereof, and a method of producing the gas barrier film.

In order to achieve the above object, according to the present invention, there is provided a gas barrier film comprising: two or more combinations of an inorganic layer and an organic layer which becomes an underlying base of the inorganic layer on one surface of a support,

in which in a case where the organic layer is provided on a surface of the support, the organic layer on the surface of the support is an underlying organic layer, and the organic layer between the inorganic layers is an intermediate organic layer, a thickness of the intermediate organic layer is 0.05 to 0.5 μm, and a ratio between the thickness of the intermediate organic layer and a thickness of the underlying organic layer is 0.1 or less, and

the intermediate organic layer contains a polymer of (meth)acrylate represented by Formula (1),

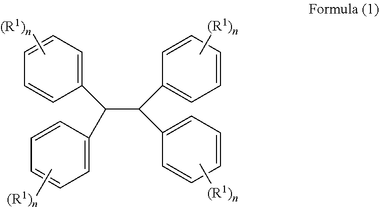

in Formula (1), R¹'s each represent a substituent and may be the same or different from each other; and n's each represent an integer of 0 to 5 and may be the same or different from each other, where at least one R¹ includes (meth)acryloyl group.

In such a gas barrier film according to the present invention, it is preferable the intermediate organic layer contains a polymer of urethane (meth)acrylate.

It is preferable that the urethane (meth)acrylate is hexafunctional or higher functional urethane (meth)acrylate.

It is preferable that the intermediate organic layer contains a polymer of (meth)acrylate having a double bond equivalent of 200 or less.

Further, it is preferable that the (meth)acrylate represented by Formula (1) is tetrafunctional or higher functional (meth)acrylate.

According to the present invention, there is provided a method of producing a gas barrier film comprising: alternately forming an organic layer and an inorganic layer on one surface of a support such that two or more layers of the organic layers and two or more layers of the inorganic layers are formed,

in a case where the organic layer is formed on a surface of the support, the organic layer which is formed on the surface of the support is an underlying organic layer, and the organic layer which is formed between the inorganic layers is an intermediate organic layer, the underlying organic layer and the intermediate organic layer are formed such that a thickness of the intermediate organic layer is 0.05 to 0.5 μm, and a ratio between the thickness of the intermediate organic layer and a thickness of the underlying organic layer is 0.1 or less, and,

the intermediate organic layer is formed by performing a coating step of applying a polymerizable composition containing (meth)acrylate represented by Formula (1) to the inorganic layer, a drying step of heating and drying the polymerizable composition applied to the inorganic layer, and a curing step of curing the dried polymerizable composition,

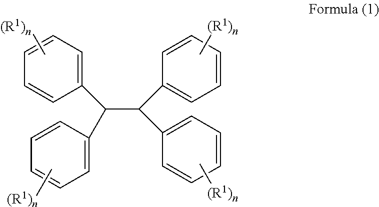

in Formula (1), R¹'s each represent a substituent and may be the same or different from each other; and n's each represent an integer of 0 to 5 and may be the same or different from each other, where at least one IV includes (meth)acryloyl group.

In the method of producing a gas barrier film according to the present invention, it is preferable that the polymerizable composition contains urethane (meth)acrylate.

It is preferable that the urethane (meth)acrylate is hexafunctional or higher functional urethane (meth)acrylate.

It is preferable that the polymerizable composition contains polyfunctional (meth)acrylate having a double bond equivalent of 200 or less.

It is preferable that the (meth)acrylate represented by Formula (1) is tetrafunctional or higher functional (meth)acrylate.

It is preferable that the inorganic layer and the organic layer are formed by a roll to roll method, after the inorganic layer is formed and before the formed inorganic layer is brought into contact with another member, a protective film is laminated on a surface of the inorganic layer, and, before the intermediate organic layer is formed, the protective film is peeled off from the inorganic layer, and before the inorganic layer is brought into contact with the other member, the coating step is performed.

It is preferable that the protective film is formed of polyolefin.

Further, it is preferable that a viscosity of the polymerizable composition is 1 Pa·s or more.

According to the present invention, it is possible to obtain a gas barrier film of an organic-inorganic lamination type having high gas barrier properties and a good adhesion force between an organic layer sandwiched between inorganic layers and a lower inorganic layer of the organic layer.

### BRIEF DESCRIPTION OF THE DRAWINGS

FIG. 1 is a diagram conceptually showing an example of a gas barrier film of the present invention.

FIG. 2 is a diagram conceptually showing an example of an organic film forming apparatus for producing the gas barrier film of the present invention.

FIG. 3 is a diagram conceptually showing an example of an inorganic film forming apparatus for producing the gas barrier film of the present invention.

### DESCRIPTION OF THE PREFERRED EMBODIMENTS

Hereinafter, a gas barrier film and a method of producing a gas barrier film according to embodiments of the present invention will be described in detail based on preferred examples shown in the accompanying drawings.

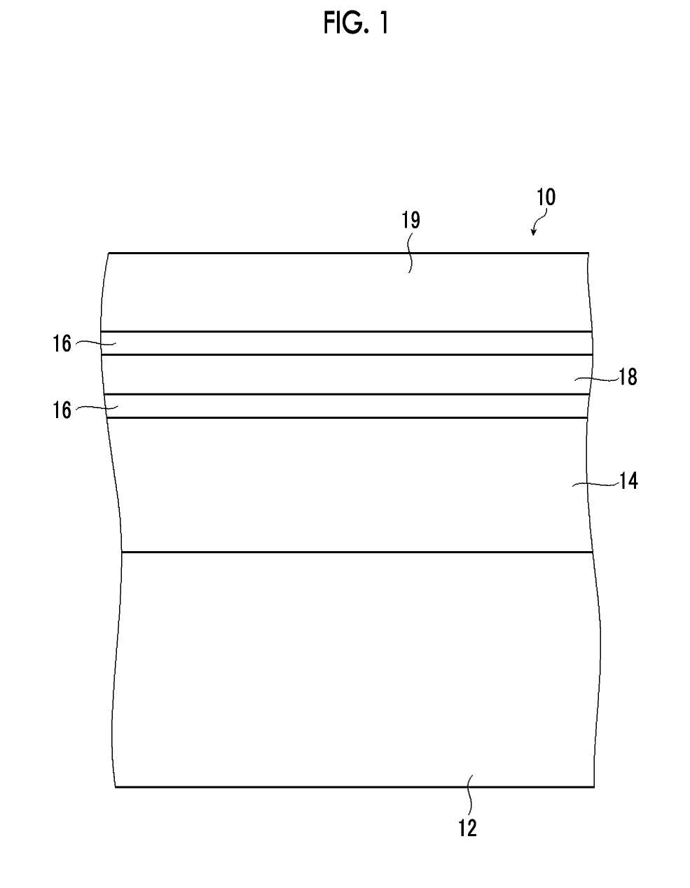

FIG. 1 conceptually shows an example of a gas barrier film according to an embodiment of the present invention.

FIG. 1 is a diagram merely conceptually shows one example of the gas barrier film according to the embodiment of the present invention, and the relationship of the thickness of each layer and the like are different from those of an actual gas barrier film according to the embodiment of the present invention.

A gas barrier film 10 shown in FIG. 1 is the above-described organic-inorganic lamination type gas barrier film formed by alternately forming an organic layer and an inorganic layer and has a constitution having a support 12, an underlying organic layer 14 which is formed on one surface of the support 12, an inorganic layer 16 which is formed on a surface of the underlying organic layer 14, an intermediate organic layer 18 which is formed on a surface of the inorganic layer 16, a second inorganic layer 16 which is formed on a surface of the intermediate organic layer 18, and a protective organic layer 19 which is formed on a surface of the second inorganic layer 16.

In the following description, the term “gas barrier film 10” is simply referred to as “barrier film 10”. In addition, in the following description, for the sake of convenience, the protective organic layer 19 side in the barrier film 10 is referred to as “upper” and the support 12 side is referred to as “lower”.

As described above, the barrier film 10 shown in FIG. 1 has the underlying organic layer 14, the first inorganic layer 16, the intermediate organic layer 18, and the second inorganic layer 16 on one surface of the support 12, and has the protective organic layer 19 on the uppermost layer.

That is, the barrier film 10 has two or more combinations of an inorganic layer and an organic layer which becomes an underlying base of the inorganic layer. However, the barrier film according to the embodiment of the present invention can adopt various layer constitutions other than this constitution.

For example, in the barrier film 10 shown in FIG. 1, a constitution having three or more combinations of an inorganic layer and an organic layer which becomes an underlying base of the inorganic layer in which the second intermediate organic layer 18 is provided on the second inorganic layer 16, a third inorganic layer 16 is provided on the intermediate organic layer 18, and the protective organic layer 19 is provided on the third organic layer is suitably adopted. In addition, a constitution having four or more combinations of an inorganic layer and an organic layer which becomes an underlying base of the inorganic layer can also be adopted.

In an organic-inorganic lamination type gas barrier film, generally, as the number of combinations of an inorganic layer 16 and an organic layer which becomes an underlying base of the inorganic layer 16 increases, higher gas barrier properties are exhibited.

In addition, the protective organic layer 19 is provided as a preferable aspect. Accordingly, the gas barrier film of the embodiment of the present invention can adopt a constitution in which the protective organic layer 19 is not provided.

That is, the gas barrier film of the embodiment of the present invention can adopt various layer constitution as long as the organic layer which becomes an underlying base of the inorganic layer 16 is provided on the surface of the support 12 and two or more combinations of an inorganic layer and an organic layer which becomes an underlying base of the inorganic layer are adopted.

In the barrier film 10, as the support 12, various known sheet-like materials that are used as a support in various gas barrier films, various lamination type functional film, and the like can be used.

Specifically, suitable examples of the support 12 include films (resin films) formed of various resin materials, such as polyethylene (PE), polyethylene naphthalate (PEN), polyamide (PA), polyethylene terephthalate (PET), polyvinyl chloride (PVC), polyvinyl alcohol (PVA), polyacrylonitrile (PAN), polyimide (PI), transparent polyimide, a methyl polymethacrylate resin (PMMA), polycarbonate (PC), polyacrylate, polymethacrylate, polypropylene (PP), polystyrene (PS), an acrylonitrile-butadiene-styrene copolymer (ABS), a cyclic olefin/copolymer (COC), a cycloolefin polymer (COP), and triacetyl cellulose (TAC).

Furthermore, in the present invention, a support having a layer (film) for obtaining various functions, such as a protective layer, an adhesive layer, a light reflecting layer, an antireflection layer, a light shielding layer, a planarizing layer, a buffer layer, and a stress relaxation layer, formed on the surface of such resin film, may be used as the support 12.

The thickness of the support 12 may be appropriately set, depending on applications, forming materials, or the like.

According to the studies of the present inventors, the thickness of the support 12 is preferably 5 to 150 μm, and more preferably 10 to 100 μm.

It is preferable to set the thickness of the support 12 within the above range from the viewpoints that the mechanical strength of the barrier film 10 is secured, and further, the barrier film 10 can be lighter, thinner, and more flexible.

The barrier film 10 has the underlying organic layer 14 on the (surface of the) support 12.

The underlying organic layer 14 is a layer formed of an organic compound, which is basically obtained by curing (crosslinking, polymerization) of monomers or oligomers which become the underlying organic layer 14.

In the barrier film 10 according to the embodiment of the present invention, the underlying organic layer of the inorganic layer 16 functions as an underlayer for forming an appropriate inorganic layer 16 which mainly exhibits gas barrier properties in the barrier film 10. That is, unevenness on the film formation surface of the inorganic layer 16 is embedded in the underlying organic layer of the inorganic layer 16 and the deposition surface of the inorganic layer 16 is brought into a state suitable for forming the inorganic layer 16.

By providing the organic layer which becomes an underlying base, it is possible to remove regions in which it is difficult to form an inorganic compound which becomes the inorganic layer 16 to be deposited, such as shadows of unevenness and the like, on the film formation surface of the inorganic layer 16, thereby forming an appropriate inorganic layer 16 over the entire surface of the film formation surface of the inorganic layer 16 without gaps.

Accordingly, the unevenness on the surface of the support 12, foreign substances adhering onto the surface of the support 12, and the like are embedded in the underlying organic layer 14 which is formed on the support 12 and the deposition surface of the inorganic layer 16 is brought into a state suitable for forming the inorganic layer 16.

In the barrier film 10, the forming materials of the underlying organic layer 14 are not limited, and various known organic compounds can be used.

Suitable examples thereof include thermoplastic resins such as polyesters, (meth)acrylic resins, methacrylic acid-maleic acid copolymers, polystyrene, transparent fluororesins, polyimide, fluorinated polyimide, polyamide, polyamideimide, polyetherimide, cellulose acylate, polyurethane, polyether ether ketone, polycarbonate, alicyclic polyolefin, polyarylate, polyether sulfone, polysulfone, fluorene ring-modified polycarbonate, alicyclic-modified polycarbonate, fluorene ring-modified polyester, and acrylic compounds, and films of polysiloxane and other organosilicon compounds. A plurality of these compounds may be used in combination.

Among those, the underlying organic layer 14 constituted with a polymer of at least one of a radically curable compound or a cationically curable compound having an ether group as a functional group is suitable from the viewpoint of excellent glass transition temperature, strength, and the like.

Among those, in particular, from the viewpoint of a low refractive index, high transparency, excellent optical characteristics, and the like, acrylic resins or methacrylic resins having polymers of monomers, dimers, and oligomers of at least one of acrylate or methacrylate as a main component are suitably exemplified as the underlying organic layer 14.

Among those, in particular, acrylic resins or methacrylic resins having bifunctional or higher functional, in particular, trifunctional or higher functional polymers of monomers, dimers, and the oligomers of at least one of acrylate or methacrylate as a main component, such as dipropylene glycol di(meth)acrylate (DPGDA), trimethylolpropane tri(meth)acrylate (TMPTA), and dipentaerythritol hexa(meth)acrylate (DPHA) are suitably exemplified. Further, it is also preferable that a plurality of these acrylic resins and methacrylic resins are used.

In addition, a polymer of (meth)acrylate represented by Formula (1) used in the intermediate organic layer 18 which will be described later can also be used as the underlying organic layer 14.

Further, a graft copolymer used in the protective organic layer 19 which will be described later can also be used as the underlying organic layer 14.

In the barrier film 10 according to the embodiment of the present invention, the thickness of the underlying organic layer 14 which is formed on the support 12 is set such that a ratio between the intermediate organic layer 18 and the thickness of the underlying organic layer 14 is 0.1 or less. That is, in the present invention, the intermediate organic layer 18 and the underlying organic layer 14 satisfy “thickness of intermediate organic layer 18/thickness of underlying organic layer 14≤0.1”.

Although described later, in the barrier film 10 according to the embodiment of the present invention, the thickness of the intermediate organic layer 18 between the inorganic layers 16 is 0.05 to 0.5 μm.

Accordingly, in the barrier film 10 according to the embodiment of the present invention, the thickness of the underlying organic layer 14 is 5 μm or more in a case where the maximum value of the thickness of the intermediate organic layer 18 is 0.5 μm, and is 0.5 μm or more in a case where the maximum value of the thickness of the intermediate organic layer 18 is 0.05 μm.

Specifically, the thickness of the underlying organic layer 14 is preferably 2 to 10 μm and is more preferably 3 to 6 μm.

One feature of the barrier film 10 according to the embodiment of the present invention is that the thickness of the intermediate organic layer 18 which is an organic layer between the inorganic layers 16 is very thin.

In the barrier film 10 according to the embodiment of the present invention, the thickness of the underlying organic layer 14 with respect to such an intermediate organic layer 18 is set such that the ratio between the thickness of the intermediate organic layer 18 and the thickness of the underlying organic layer 14 is 0.1 or more. That is, in the barrier film 10 according to the embodiment of the present invention, the thickness of the underlying organic layer 14 is at least 0.5 μm or more and is sufficiently thick compared to the intermediate organic layer 18. Since the barrier film 10 according to the embodiment of the present invention has such a constitution, the unevenness on the surface of the support 12 and foreign substances adhering onto the surface of the support 12 are embedded and the surface of the underlying organic layer 14, that is, the deposition surface of the first inorganic layer 16 can be flattened, thereby appropriately forming the first inorganic layer 16 over the entire surface without gaps.

In a case where the thickness of the underlying organic layer 14 is more than 0.1 in terms of the ratio between the thickness of the intermediate organic layer 18 and the thickness of the underlying organic layer 14, the underlying organic layer 14 is excessively thin and cannot sufficiently function as an underlying base of the first inorganic layer 16 and it is difficult to form an appropriate first inorganic layer 16.

The ratio between the thickness of the intermediate organic layer 18 and the thickness of the underlying organic layer 14 is preferably 0.07 or less and more preferably 0.05 or less.

In addition, preferably, by setting the thickness of the underlying organic layer 14 to 10 μm or less, it is possible to suitably suppress the occurrence of problems such as cracks in the underlying organic layer 14 and curling of the barrier film 10 due to the excessive thickness of the underlying organic layer 14.

Such an underlying organic layer 14 may be formed (film formation) by a known method of forming a layer formed of an organic compound depending on the underlying organic layer 14 to be formed.

As an example, the underlying organic layer 14 may be formed by a so-called coating method, which includes preparing a polymerizable composition (coating composition) including an organic solvent, an organic compound (monomer, dimer, trimer, oligomer, polymer, and the like), which become the underlying organic layer 14, a surfactant, a silane coupling agent, and a photopolymerization initiator; applying and drying the polymerizable composition; and as necessary, curing (crosslinking) the polymerizable compound by the irradiation with ultraviolet rays, or the like.

In addition, the underlying organic layer 14 is preferably formed by a so-called roll to roll method. In the following description, the “roll to roll” is also referred to as “R to R”.

As is well known, R to R is a production method in which a material for film ormation is drawn from a material roll formed by rolling up the material for film formation having a long length into a roll shape, film formation is carried out while the drawn material for film formation is transported in a longitudinal direction, and the film-formed material for film formation is rolled in a roll shape. By using R to R, high productivity and production efficiency are obtained.

The first inorganic layer 16 is formed on the underlying organic layer 14, the intermediate organic layer 18 is formed on the first inorganic layer, and the second inorganic layer 16 is formed on the intermediate organic layer.

In the barrier film 10, the inorganic layer 16 mainly exhibits the desired gas barrier properties.

The forming materials of the inorganic layer 16 are not limited, and various layers formed of inorganic compounds exhibiting gas barrier properties can be used.

Specifically, films formed of inorganic compounds including metal oxides such as aluminum oxide, magnesium oxide, tantalum oxide, zirconium oxide, titanium oxide, and indium tin oxide (ITO); metal nitrides such as aluminum nitride; metal carbides such as aluminum carbide; oxides of silicon such as silicon oxide, silicon oxynitride, silicon oxycarbide, and silicon oxynitrocarbide; nitrides of silicon such as silicon nitride and silicon nitrocarbide; carbides of silicon such as silicon carbide; hydrides of these compounds; mixtures of two or more thereof; and hydrogen-containing products thereof are suitably exemplified. Further, a mixture of two or more of these compounds can also be used.

In particular, silicon nitride, silicon oxide, silicon oxynitride, aluminum oxide, and a mixture of two or more thereof are suitably used for the gas barrier film since these compounds can exhibit high transparency and excellent gas barrier properties. Among these, in particular, silicon nitride is suitably used since the silicon nitride exhibits high transparency as well as excellent gas barrier properties.

As the film thickness of the inorganic layer 16, a thickness capable of exhibiting the desired gas barrier properties may be appropriately determined depending on the forming materials. According to the studies of the present inventors, the thickness of the inorganic layer 16 is preferably 10 to 200 nm, more preferably 15 to 100 nm, and particularly preferably 20 to 75 nm.

By setting the thickness of the inorganic layer 16 to 10 nm or more, the inorganic layer 16 that stably exhibits sufficient gas barrier properties can be formed. Further, the inorganic layer 16 is generally brittle, and thus, in a case where the inorganic layer is excessively thick, the inorganic layer can cause generation of cracking, lines, peeling, or the like, whereas by setting the thickness of the inorganic layer 16 to 200 nm or less, the generation of cracks can be prevented.

In a case where a plurality of inorganic layers 16 are included as described above, the thickness of the respective inorganic layers 16 may be the same or different from each other. Further, in a case where a plurality of the inorganic layers 16 are included, the forming materials of the respective inorganic layers 16 may be the same or different from each other.

In the barrier film 10, a film forming method of the inorganic layer 16 is not limited, and various known methods of forming inorganic layers (inorganic films) can be used, depending on the inorganic layer 16 to be formed.

Specifically, the inorganic layer 16 may be formed by vapor phase film forming methods including plasma CVDs such as capacitively coupled plasma (CCP)-chemical vapor deposition (CVD) and inductively coupled plasma (ICP)-CVD, sputtering such as magnetron sputtering and reactive sputtering, and vacuum vapor deposition.

In addition, the inorganic layer 16 is also preferably formed by R to R.

As described above, the intermediate organic layer 18 is formed on the first inorganic layer 16. Further, the second inorganic layer 16 is formed on the intermediate organic layer 18.

That is, the intermediate organic layer 18 is an organic layer which becomes an underlying base of the inorganic layer 16 to appropriately form the second inorganic layer 16 to be formed on the intermediate organic layer.

The intermediate organic layer 18 is an organic layer between the inorganic layers 16 and in other words, is an organic layer which is sandwiched between the inorganic layers 16.

As described above, the gas barrier film according to the embodiment of the present invention has two or more combinations of an organic layer which becomes an underlying base and an inorganic layer. Accordingly, for example, in a case where the gas barrier film has three combinations of an organic layer which becomes an underlying base and an inorganic layer 16, there are two intermediate organic layers 18 each of which is an organic layer between the inorganic layers 16, and in a case where the gas barrier film has four combinations of an organic layer which becomes an underlying base and an inorganic layer, there are three intermediate organic layers 18 each of which is an organic layer between the inorganic layer 16.

Here, as described above, the inorganic layer 16 is formed by plasma CVD or the like. Therefore, in a case where the inorganic layer 16 is formed on the intermediate organic layer 18, the intermediate organic layer 18 is etched by plasma for forming the inorganic layer 16 and a mixed layer in which the forming component of the intermediate organic layer 18 and the forming component of the inorganic layer 16 are mixed may be formed between the intermediate organic layer 18 and the upper inorganic layer 16. Regarding the mixed layer, the same applies between the above-described underlying organic layer 14 and the first inorganic layer 16 on the underlying organic layer.

In a case where such a mixed layer is formed, the adhesion force between the intermediate organic layer 18 and the upper inorganic layer 16 is improved.

Alternatively, in order to improve the adhesion force between the intermediate organic layer 18 and the upper inorganic layer 16, the mixed layer may be intentionally formed at the time of forming the inorganic layer 16. In this case, in a case where the thickness of the mixed layer is 5 nm or more, an effect of improving the adhesion force can be more suitably obtained. The thickness of the mixed layer is defined as the maximum thickness of a region having both an inorganic layer and an organic layer forming material. However, in order to obtain necessary gas barrier properties, the thickness of the mixed layer is preferably 50% or less of the thickness of the inorganic layer 16.

The formation of such an intentional mixed layer and the thickness of the mixed layer to be formed can be controlled by, for example, in a case where an organic layer is formed by plasma CVD, adjustment of plasma excitation power, adjustment of bias power to be applied to the surface to be deposited, adjustment of the composition and supply amount of a raw material gas, and the like.

In the barrier film 10 according to the embodiment of the present invention, the thickness of the intermediate organic layer 18 which is an organic layer between the inorganic layers 16 is 0.05 to 0.5 μm and as described above, the ratio between the thickness of the intermediate organic layer 18 and the thickness of the underlying organic layer 14 is 0.1 or less.

As described above, in a case where the mixed layer is formed between the organic layer and the upper inorganic layer, the mixed layer is considered as a part of the organic layer. Accordingly, in a case where the mixed layer is formed, the thickness of the intermediate organic layer 18 and the underlying organic layer 14 is a thickness including the mixed layer and in the organic layer-mixed layer-inorganic layer laminate, the film thickness of the thickest part in which the forming material of the organic layer is present is set to a thickness of the intermediate organic layer 18 and the underlying organic layer 14.

In addition, the intermediate organic layer 18 includes a polymer of (meth)acrylate represented by Formula (1).

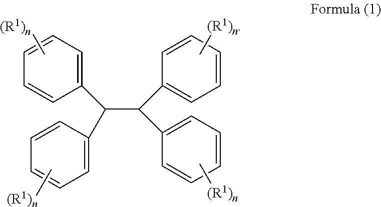

In Formula (1), R¹'s each represent a substituent and may be the same or different from each other, and n's each represent an integer of 0 to 5 and may be the same or different from each other, where at least one R¹ includes (meth)acryloyl group.

Further, the intermediate organic layer 18 preferably includes a polymer of urethane (meth)acrylate or a polymer of (meth)acrylate having a double bond equivalent of 200 or less, and more preferably includes a polymer of urethane (meth)acrylate and a polymer of (meth)acrylate having a double bond equivalent of 200 or less.

Specifically, the intermediate organic layer 18 is a layer formed by preparing a polymerizable composition (coating composition) containing (meth)acrylate represented by Formula (1), preferably, at least one of urethane (meth)acrylate or (meth)acrylate having a double bond equivalent of 200 or less, applying the prepared polymerizable composition to the inorganic layer 16, heating and drying the applied polymerizable composition, and further, curing the polymerizable composition (crosslinking (polymerizing) an organic compound).

That is, as a preferable aspect, in a case where the polymerizable composition for forming the intermediate organic layer 18 contains urethane (meth)acrylate and (meth)acrylate having a double bond equivalent of 200 or less in addition to (meth)acrylate represented by Formula (1), the intermediate organic layer 18 contains a polymer of (meth)acrylate represented by Formula (1) as a main component (maximum component), and also contains a polymer of urethane (meth)acrylate, a polymer of (meth)acrylate having a double bond equivalent of 200 or less, a polymer of (meth)acrylate represented by Formula (1) and urethane (meth)acrylate, a polymer of (meth)acrylate represented by Formula (1) and (meth)acrylate having a double bond equivalent of 200 or less, a polymer of urethane (meth)acrylate and (meth)acrylate having a double bond equivalent of 200 or less, a polymer of (meth)acrylate represented by Formula (1), urethane (meth)acrylate, and (meth)acrylate having a double bond equivalent of 200 or less, and the like.

Since the barrier film 10 according to the embodiment of the present invention has such a constitution, a barrier film 10 which has excellent gas barrier properties and sufficient adhesion force between the intermediate organic layer 18 between the inorganic layers 16 and the lower inorganic layer 16 of the intermediate organic layer 18 is realized.

As is well known, adhesion force is low between a layer formed of an inorganic compound and a layer formed of an organic compound. Therefore, as described in JP2015-044393A, in the organic-inorganic lamination type gas barrier film, by incorporating a silane coupling agent or the like in the polymerizable composition for forming the organic layer, the adhesion force between the organic layer and the lower inorganic layer is secured.

However, according to the studies of the present inventors, in a case where two or more combinations of an organic layer which becomes an underlying base and an inorganic layer 16 are included, even in a case where a silane coupling agent or the like is added to the organic layer, it is not always possible to obtain sufficient adhesion force between the intermediate organic layer 18 to be formed between the inorganic layers 16 and the lower inorganic layer 16 in some cases.

That is, as described above, usually, the organic layer is formed by preparing a polymerizable composition containing an organic compound which becomes an organic layer and drying and curing this coating.

Here, in a general organic-inorganic lamination type gas barrier film, the thickness of an organic layer is usually about 1 to 2 μm. In a case where the organic layer has such a thickness, the adhesion force between the organic layer to be formed on the inorganic layer 16 and the lower inorganic layer 16 is reduced due to stress generated at the time of curing of the polymerizable composition.

In addition, an inorganic layer 16 is formed on the intermediate organic layer 18 to be formed between the inorganic layers 16. As described above, the inorganic layer 16 is a layer having a higher density than that of the organic layer formed by plasma CVD or the like. Therefore, the intermediate organic layer 18 between the inorganic layers 16 is also affected by the stress of the upper inorganic layer 16, in addition to its own stress, and further, the adhesion force with the lower inorganic layer 16 is reduced. In addition, in a case where the above-described mixed layer is formed between the intermediate organic layer 18 and the upper inorganic layer 16, since the adhesion force between the intermediate organic layer 18 and the upper inorganic layer 16 is increased, the influence of the stress received from the upper inorganic layer 16 becomes stronger, and the adhesion force with the lower inorganic layer 16 is further reduced.

Therefore, in the organic-inorganic lamination type gas barrier film, the adhesion force between the intermediate organic layer 18 to be provided between the inorganic layers 16 and the lower inorganic layer 16 becomes very low.

In order to avoid such inconvenience, the intermediate organic layer 18 to be provided between the inorganic layers 16 may be made thin to reduce the stress of the intermediate organic layer 18 itself

However, in order to sufficiently reduce the influence of the stress, it is required to make the intermediate organic layer 18 very thin. Therefore, it becomes difficult to appropriately form the intermediate organic layer 18 over the entire surface of the inorganic layer 16.

That is, as described above, the organic layer including the intermediate organic layer 18 is formed by a so-called coating method including preparing a polymerizable composition an organic compound which becomes the organic layer, applying the polymerizable composition to a film formation surface, drying the polymerizable composition, and curing the polymerizable composition after drying.

In the film formation of the organic layer by the coating method, the polymerizable composition is usually dried by heating. By heating at the time of drying of the polymerizable composition, the film of the polymerizable composition is softened. The fluidity of the softened film of the polymerizable composition becomes high. Therefore, in a case where the intermediate organic layer 18, that is, the film of the polymerizable composition is thin, so-called cissing is caused by the flow of the film, and the film of the polymerizable composition does not appropriately cover the entire surface of the lower inorganic layer 16.

In a case where a large amount of thickener is added to the polymerizable composition, such inconvenience can be avoided. In general, urethane-based compounds can be used as thickeners. However, a urethane-based compound generally has low plasma resistance.

Therefore, in a case where the intermediate organic layer 18 contains a large amount of thickener, the intermediate organic layer which covers the entire surface of the lower inorganic layer 16 can be formed. However, in a case where the upper inorganic layer 16 is formed by plasma CVD or the like, the thickener included in the intermediate organic layer 18 is etched and the intermediate organic layer 18 is full of defects. Thus, it is difficult to form an inorganic layer 16 appropriate for an upper layer.

Further, although described later, in a production method according to an embodiment of the present invention, as a preferable aspect, the inorganic layer 16 and the organic layer are formed by R to R. Here, in the present invention, in order to protect the inorganic layer 16, before the inorganic layer 16 is brought into contact with any member after the inorganic layer 16 is formed, a protective film Gb is laminated on the inorganic layer 16. In addition, when the intermediate organic layer 18 is formed, the protective film Gb is peeled off before the intermediate organic layer 18 is formed, and before the inorganic layer 16 is brought into contact with any member, the polymerizable composition for forming the intermediate organic layer 18 is applied to the inorganic layer 16.

In the production method according to the embodiment of the present invention, the damage of the inorganic layer 16 is prevented and thus it is possible to produce a barrier film 10 having very high gas barrier properties which maximizes the high gas barrier properties possessed by the inorganic layer 16.

Since the protective film Gb is laminated on the inorganic layer 16 in vacuum after the inorganic layer 16 is formed, the protective film is laminated on the inorganic layer 16 with a very high adhesion force. Therefore, in a case where the protective film Gb is peeled off to form the intermediate organic layer 18, the protective film Gb is slightly transferred to the surface of the inorganic layer 16.

Generally, the protective film Gb is a film formed of polyolefin such as PE or PP. In a case where the polyolefin remains on the surface of the inorganic layer 16, the wettability of the polymerizable composition is reduced and cissing easily occurs. Further, the film of the polymerizable composition is difficult to appropriately cover the entire surface of the lower inorganic layer 16.

In contrast, in the barrier film 10 according to the embodiment of the present invention, the film thickness of the intermediate organic layer 18 between the inorganic layers 16 is 0.05 to 0.5 μm, and the ratio between the thickness of the intermediate organic layer 18 and the thickness of the underlying organic layer 14 is 0.1 or less.

Further, the intermediate organic layer 18 includes a polymer of (meth)acrylate represented by Formula (1). That is, in the present invention, the polymerizable composition for forming the intermediate organic layer 18 contains (meth)acrylate represented by Formula (1).

According to the present invention, since the thickness of the intermediate organic layer 18 is 0.05 to 0.5 μm and is sufficient, due to the stress of the intermediate organic layer 18, a reduction in the adhesion force with the lower inorganic layer 16 is greatly decreased and thus the adhesion force between the intermediate organic layer 18 and the lower inorganic layer 16 can be secured.

Since the intermediate organic layer 18 is formed on the inorganic layer 16 formed by plasma CVD or the like on the organic layer which becomes an underlying base, even at a thickness of 0.05 μm, an action as an underlayer for sufficiently embedding the unevenness of the lower inorganic layer 16 or the like to appropriately form the upper inorganic layer 16 can be exhibited.

In a case where the thickness of the intermediate organic layer 18 is less than 0.5 μm, a function as an underlayer of the inorganic layer 16 is not sufficient and the appropriate inorganic layer 16 cannot be formed in the upper layer, so that the desired gas barrier properties cannot be obtained.

In contrast, in a case where the thickness of the intermediate organic layer 18 is more than 0.05 μm, the stress of the intermediate organic layer 18 becomes stronger and a sufficient adhesion force with the lower inorganic layer 16 cannot be obtained.

According to the studies by the present inventors, the film thickness of the intermediate organic layer 18 is preferably 0.25 to 0.15 μm, more preferably 0.4 to 0.1 μm.

In the present invention, in a case where a plurality of intermediate organic layer 18 are provided, the intermediate organic layer 18 may have the same thickness or an intermediate organic layer 18 having a different thickness may be present.

In addition, as described above, the intermediate organic layer 18 contains a polymer of (meth)acrylate represented by Formula (1). That is, the polymerizable composition for forming the intermediate organic layer 18 contains (meth)acrylate represented by Formula (1).

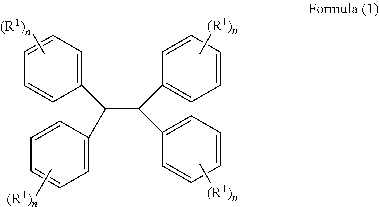

In Formula (1), R¹'s each represent a substituent and may be the same or different from each other; and n's each represent an integer of 0 to 5 and may be the same or different from each other, where at least one R¹ includes (meth)acryloyl group.

The (meth)acrylate represented by Formula (1) has a high viscosity and a high plasma resistance of the polymer.

Therefore, by incorporating the (meth)acrylate represented by Formula (1) in the polymerizable composition for forming the intermediate organic layer 18, the polymerizable composition can maintain sufficient viscosity even in a state of being heated for drying. As a result, even in a case where the film of the polymerizable composition for forming the intermediate organic layer 18 is thin, cissing does not occur. Therefore, an appropriate intermediate organic layer 18 can be formed by covering the inorganic layer 16 over the entire surface, with the polymerizable composition for forming the intermediate organic layer 18 appropriately covering the entire surface of the lower inorganic layer 16. In addition, in a case where the inorganic layer 16 is formed on the upper layer by plasma CVD or the like, the intermediate organic layer 18 has sufficient plasma resistance, and thus it is possible to form an appropriate inorganic layer 16 over the entire surface without defects.

In particular, by using tetrafunctional or higher functional (meth)acrylate represented by Formula (1), more suitable effects can be obtained from the viewpoint of improvement in the viscosity of the polymerizable composition and plasma resistance.

In the (meth)acrylate represented by Formula (1), as the substituent of the R¹, a group formed by combining one or more of —CR²₂— (R² represents a hydrogen atom or a substituent), —CO—, —O—, a phenylene group, —S—, —C≡C—, —NR³— (R³ represents a hydrogen atom or a substituent), and —CR⁴═CR⁵— (R⁴ and R⁵ each represent a hydrogen atom or a substituent) with a polymerizable group is exemplified and a group formed by combining one or more of —CR²₂— (R² represents a hydrogen atom or a substituent), —CO—, —O—, and a phenylene group and (meth)acryloyl group is preferable.

R² represents a hydrogen atom or a substituent and preferably represents a hydrogen atom or a hydroxy group.

At least one R¹ preferably includes a hydroxyl group.

The molecular weight of at least one R¹ is preferably 10 to 250 and more preferably 70 to 150.

The position where R¹ is bonded is preferably bonded to at least the para-position. n's each represent an integer of 0 to 5, preferably represent an inter of 0 to 2, and more preferably represent 0 or 1, and all of n's even more preferably represent 1.

In the (meth)acrylate represented by Formula (1), it is preferable that at least two of R¹'s have the same structure. Further, it is more preferable that all of n's represent 1 and at least each two of four R¹'s have the same structure respectively and it is even more preferable that all of n's represent 1 and four R¹'s have the same structure.

In the (meth)acrylate represented by Formula (1), the number of (meth)acryloyl groups is preferably 2 or more, more preferably 3 or more, and particularly preferably 4 or more. That is, as described above, the (meth)acrylate represented by Formula (1) is particularly preferably tetrafunctional or higher functional methacrylate.

In addition, the upper limit of the number of (meth)acryloyl groups of the (meth)acrylate represented by Formula (1) is not limited but is preferably 8 or less and more preferably 6 or less.

The molecular weight of the (meth)acrylate represented by Formula (1) is preferably 600 to 1400 and more preferably 800 to 1200.

Specific examples of the (meth)acrylate represented by Formula (1) are shown below, but the present invention is not limited thereto. In addition, the following (meth)acrylates indicate a case where all of four n's in Formula (1) represent 1, but one in which one, two or three among the four n's in Formula (1) represent 0, and one in which one, two, or three or more among the four n's in Formula (1) represent 2 or more (one in which two or more R¹'s are bonded to one ring) are also exemplified as the (meth)acrylate represented by Formula (1).

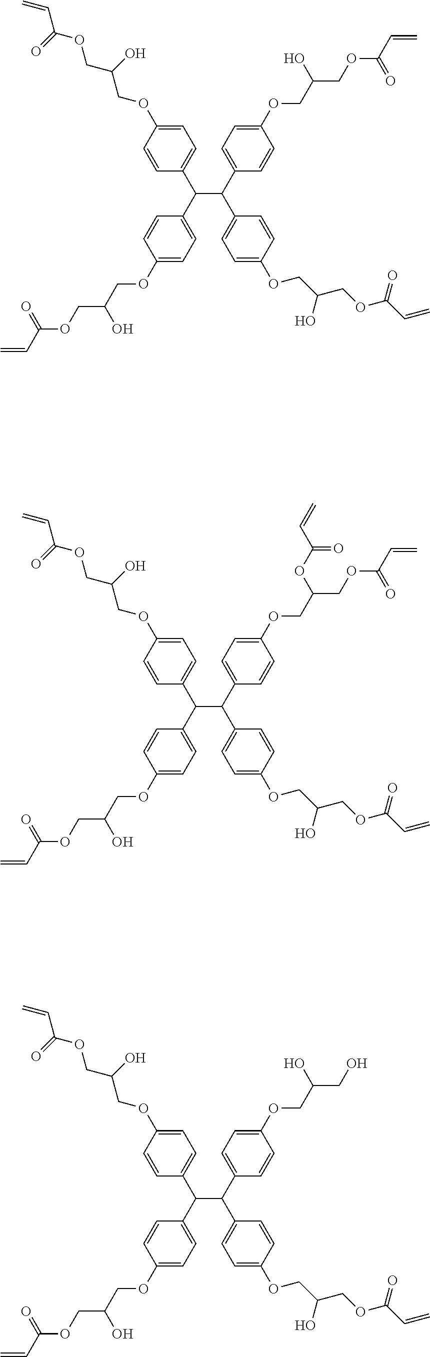

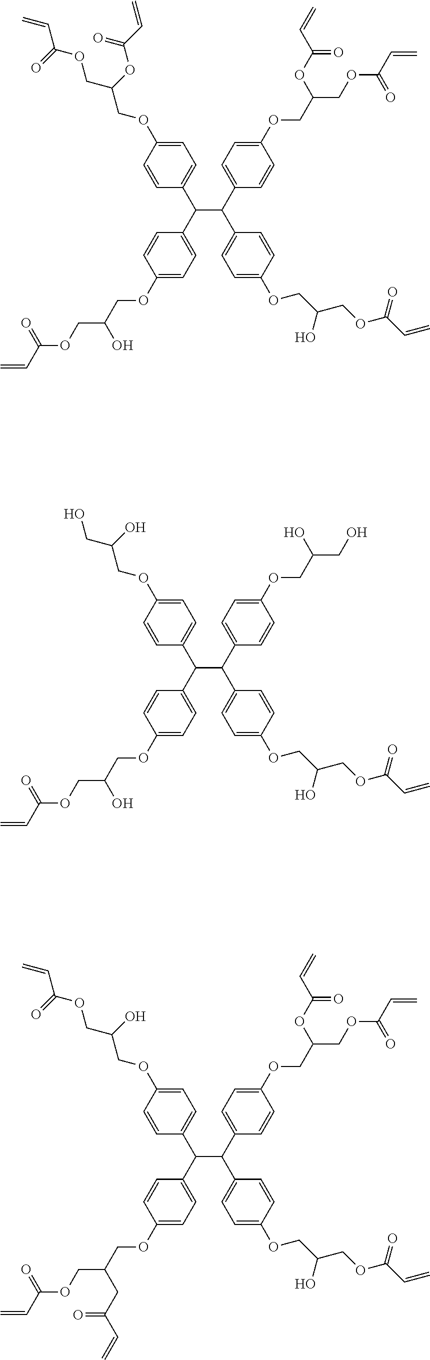

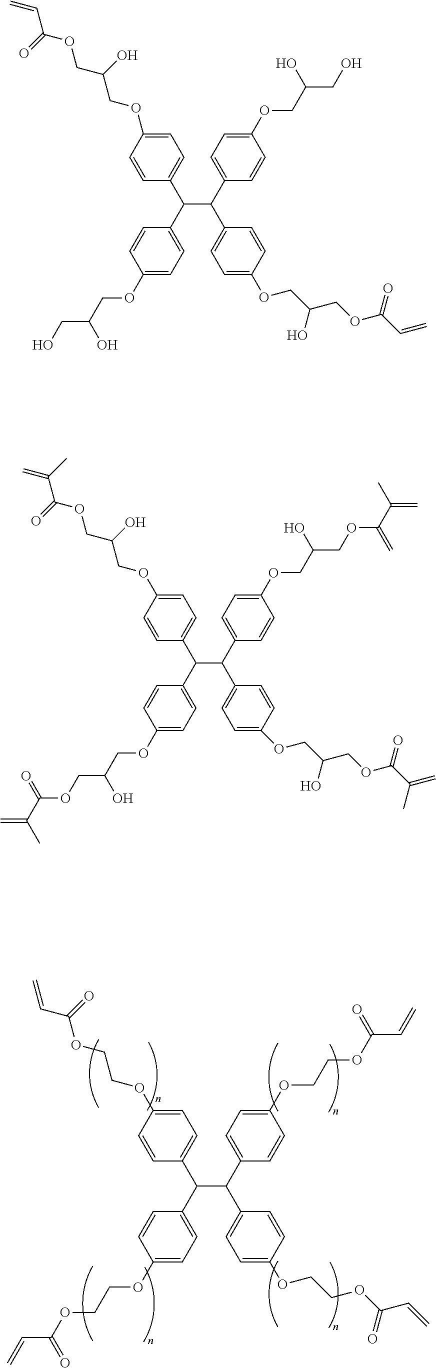

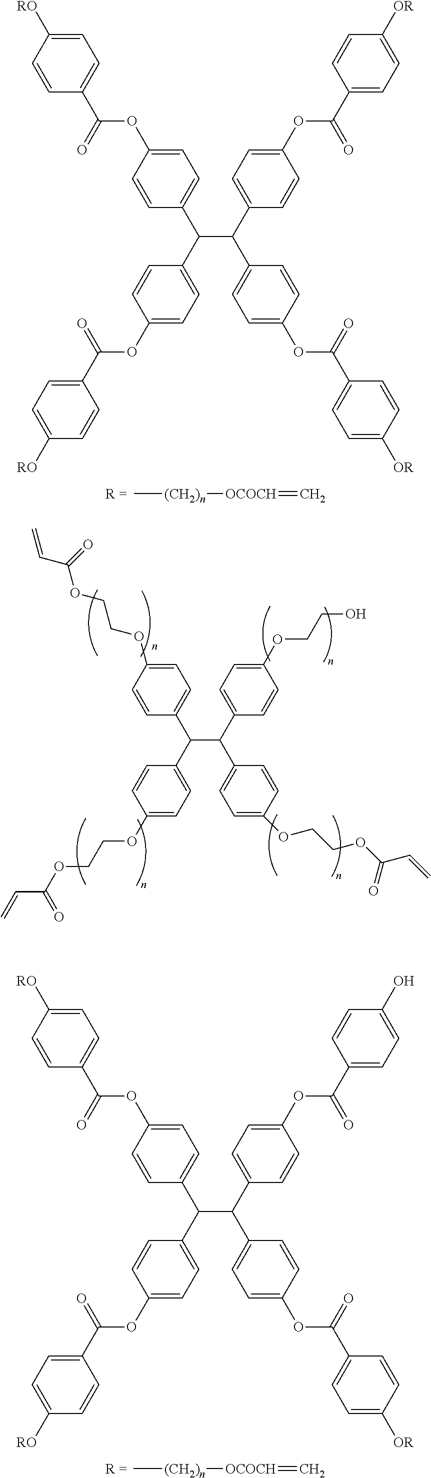

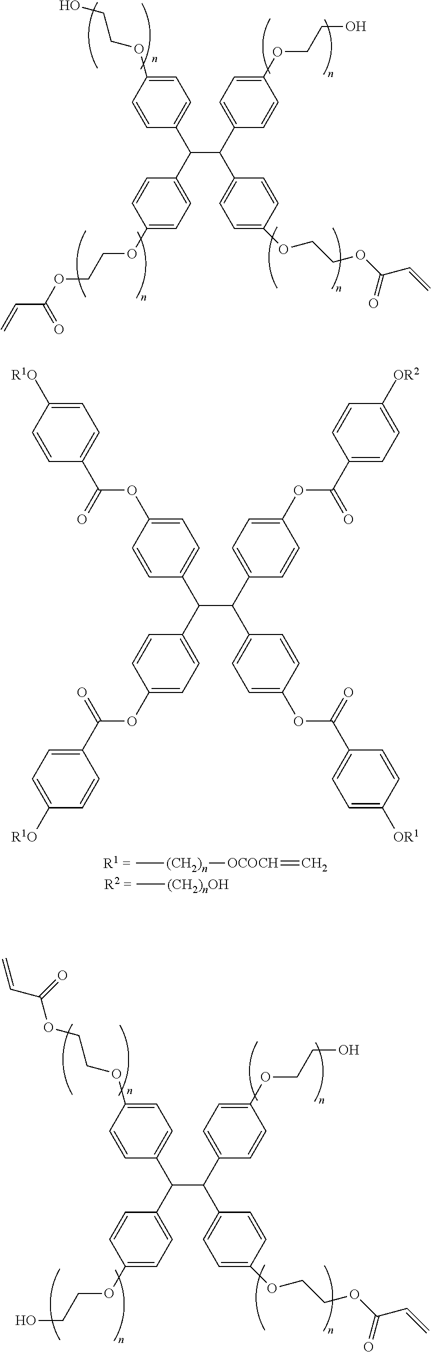

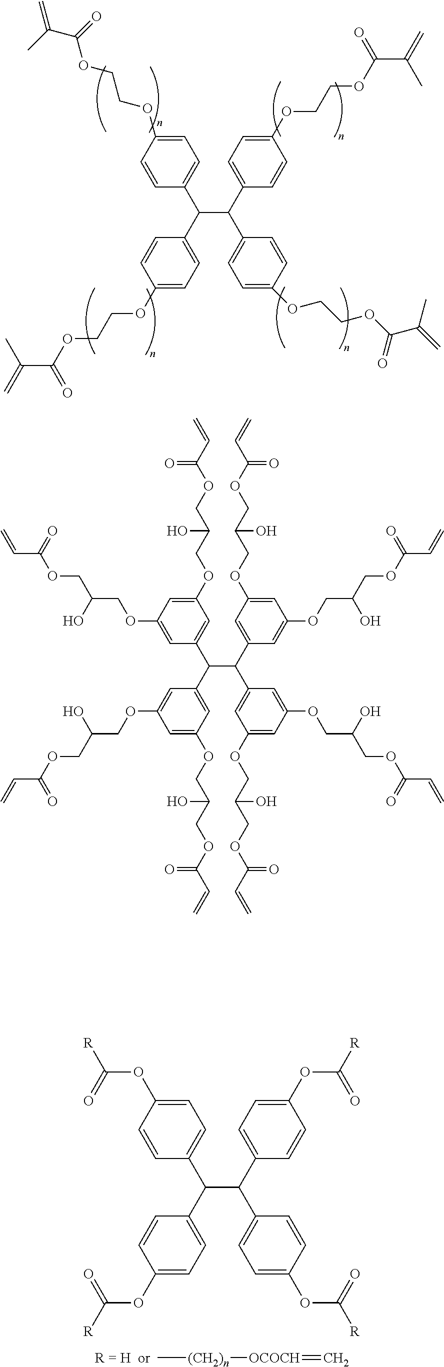

The (meth)acrylate represented by Formula (1) is available as a commercially available product, for example, NK OLIGO EA-8720 manufactured by Shin Nakamura Chemical Co., Ltd. In addition, the (meth)acrylate represented by Formula (1) can be synthesized by a known method of synthesizing a 1,1,2,2-tetraphenyl ethane derivative. In addition, a plurality of (meth)acrylates represented by Formula (1) may be used in combination.

As an example, the (meth)acrylate represented by Formula (1) can be synthesized by a method generally known as a Williamson's ether synthesis method. Specifically, the (meth)acrylate can be synthesized by using 1,1,2,2-tetra(4-hydroxyphenyl)ethane and (meth)acrylic acid alkyl halide as raw material compounds and applying a strong base such as sodium hydride and potassium t-butoxide.

These (meth)acrylates usually produce isomers and the like which are different from the desired (meth)acrylate monomer during the reaction. In a case where separation of these isomers is desired, the isomers can be separated by column chromatography.

The polymer of the (meth)acrylate represented by Formula (1) preferably has a glass transition temperature (Tg) of 200° C. or higher.

By setting the Tg of the polymer of the (meth)acrylate represented by Formula (1) to 200° C. or higher, the plasma resistance of the intermediate organic layer 18 is improved so that a suitable inorganic layer 16 can be formed and a barrier film 10 having higher gas barrier properties can be obtained. In the present invention, Tg can be measured by Japanese industrial standards (JIS) K 7121 according to differential scanning calorimetry. In addition, as the Tg, the numerical values described in the catalogues and the like may be used.

The intermediate organic layer 18 preferably contains a polymer of urethane (meth)acrylate. That is, the polymerizable composition for forming the intermediate organic layer 18 preferably contains urethane (meth)acrylate.

By incorporating urethane (meth)acrylate in the polymerizable composition for forming the intermediate organic layer 18, the viscosity of the polymerizable composition is improved and the polymerizable composition can maintain sufficient viscosity even in a state of being heated for drying. Thus, it is possible to prevent the cissing of the polymerizable composition and to form an appropriate intermediate organic layer 18 over the entire surface of the lower inorganic layer 16.

For the urethane (meth)acrylate, various known materials can be used.

As an example, a graft copolymer having an acrylic polymer as a main chain and at least one of a urethane polymer of an acryloyl group at a terminal or a urethane oligomer of an acryloyl group at a terminal as a side chain is exemplified.

Further, for the urethane (meth)acrylate, a compound having a fluorene skeleton can also be suitably used.

For the urethane (meth)acrylate, a compound in which the main chain portion of the bifunctional or higher functional (meth)acrylate exemplified for the underlying organic layer 14 above is urethane is also preferably exemplified.

A plurality of urethane (meth)acrylates may be used in combination.

By using these compounds, particularly the graft copolymer exemplified first, as the urethane (meth)acrylate, the thickening effect of the polymerizable composition for forming the intermediate organic layer 18 is suitably obtained and thus a good intermediate organic layer 18 can be formed over the entire surface of the lower inorganic layer 16.

In addition, by using the compound having a fluorene skeleton as the urethane (meth)acrylate, the Tg of the intermediate organic layer 18 is increased to improve the plasma resistance so that a suitable inorganic layer 16 can be formed and a barrier film 10 having higher gas barrier properties can be obtained.

The urethane (meth)acrylate is preferably hexafunctional or higher functional urethane (meth)acrylate. By using the hexafunctional or higher functional urethane (meth)acrylate, the Tg of the intermediate organic layer 18 is increased to improve the plasma resistance of the intermediate organic layer 18 so that a suitable inorganic layer 16 can be formed and a barrier film 10 having higher gas barrier properties can be obtained.

The viscosity of the urethane (meth)acrylate at 25° C. is preferably 50 Pa·s or more. By using the urethane (meth)acrylate having a viscosity of 50 Pa·s or more at 25° C., the thickening effect of the polymerizable composition for forming the intermediate organic layer 18 is suitably obtained and thus a good intermediate organic layer 18 can be formed over the entire surface of the inorganic layer 16.

In the present invention, the viscosity may be measured at 25° C. at a rotation speed of 60 revolution per minute (rpm) using a B type viscometer according to JIS Z 8803.

Further, the urethane (meth)acrylate is preferably a polymer having a weight-average molecular weight of 10000 or more. By using the polymer having a weight-average molecular weight of 10000 or more as the urethane (meth)acrylate, similarly, the thickening effect of the polymerizable composition for forming the intermediate organic layer 18 is suitably obtained and thus a good intermediate organic layer 18 can be formed over the entire surface of the lower inorganic layer 16.

In the present invention, the weight-average molecular weight (Mw) of the polymer may be measured as molecular weight in terms of polystyrene (PS) by gel permeation chromatography (GPC). More specifically, the weight-average molecular weight may be determined using HLC-8220 (manufactured by Tosoh Corporation), and using TSKgel Super AWM-H (manufactured by Tosoh Corporation, 6.0 mm ID×15.0 cm) as a column and a 10-mmol/L lithium bromide N-methylpyrrolidinone (NMP) solution as an eluent.

As the weight-average molecular weight of polymers and the like, the numerical values described in the catalogues and the like may be used.

As the urethane (meth)acrylate, commercially available products may be used.

Examples of commercially available products of urethane (meth)acrylate include ACRYD 8BR 600, and ACRYD 8DK 2030 manufactured by Taisei Fine Chemical Co., Ltd., and U-6HA, U-6LPA, and U-15HA manufactured by Shin Nakamura Chemical Co., Ltd.

As described above, the intermediate organic layer 18 preferably contains a polymer of (meth)acrylate having a double bond equivalent (acrylic equivalent) of 200 or less. That is, the polymerizable composition for forming the intermediate organic layer 18 contains (meth)acrylate having a double bond equivalent (acrylic equivalent) of 200 or less.

By incorporating the (meth)acrylate having a double bond equivalent (acrylic equivalent) of 200 or less in the polymerizable composition for forming the intermediate organic layer 18, the curing at the time of forming the intermediate organic layer 18, that is, the polymerization of each polymerizable compound, is stabilized and thus an intermediate organic layer 18 having a more stable quality can be formed.

As the (meth)acrylate having a double bond equivalent of 200 or less, all known (meth)acrylates having a double bond equivalent of 200 or less, such as the above-described TMPTA and DPHA, can be used. A plurality of (meth)acrylates having a double bond equivalent of 200 or less may be used in combination.

The double bond equivalent of the (meth)acrylate may be calculated by the chemical formula of the compound. In a case where the double bond equivalent of the (meth)acrylate cannot be calculated by the chemical formula, the double bond equivalent may be measured by a known method. Further, as the double bond equivalent of the (meth)acrylate, the numerical values described in the catalogues and the like may be used.

As described above, the intermediate organic layer 18 is formed by preparing a polymerizable composition obtained by dissolving or dispersing the (meth)acrylate represented by Formula (1) in a solvent, applying this polymerizable composition to the surface of the inorganic layer 16, heating and drying the polymerizable composition, and then polymerizing (curing) the polymerizable composition by, for example, irradiation with an ultraviolet ray.

Preferably, the intermediate organic layer 18 is formed by preparing a polymerizable composition obtained by dissolving or dispersing at least one of urethane (meth)acrylate or (meth)acrylate having a double bond equivalent of 200 or less in a solvent in addition to the (meth)acrylate represented by Formula (1), applying this polymerizable composition, heating and drying the polymerizable composition, and then polymerizing the polymerizable composition in the same manner.

For the solvent, those capable of dissolving or dispersing each component may be appropriately selected and used. Also, the intermediate organic layer 18 is also preferably formed of R to R.

Here, in the polymerizable composition for forming the intermediate organic layer 18, the content of the (meth)acrylate represented by Formula (1) is preferably 50% to 90% by mass and more preferably 60% to 80% by mass.

In addition, in the polymerizable composition for forming the intermediate organic layer 18, the content of the urethane (meth)acrylate is preferably 0.1% to 5% by mass and more preferably 0.5 to 2% by mass.

Further, in the polymerizable composition for forming the intermediate organic layer 18, the content of the (meth)acrylate having a double bond equivalent of 200 or less is preferably 5% to 45% by mass and more preferably 10% to 35% by mass.

In the polymerizable composition for forming the intermediate organic layer 18, by setting the contents of these components to be in the above ranges, it is possible to form an appropriate intermediate organic layer 18 having good plasma resistance and covering the entire surface of the lower inorganic layer 16.

To the polymerizable composition for forming the intermediate organic layer 18, at least one of a silane coupling agent or a photopolymerization initiator may be added, as necessary.

As the silane coupling agent and the photopolymerization initiator, various known compounds, commercially available products and the like can be used according to on the component contained in the polymerizable composition and the like.

The amount of the silane coupling agent and the photopolymerization initiator added to the polymerizable composition for forming the intermediate organic layer 18 may be appropriately set according to the kind of the silane coupling agent and the photopolymerization initiator and the like.

The viscosity of the polymerizable composition for forming the intermediate organic layer 18 at 25° C. is preferably 1 Pa·s or more and more preferably 5 Pa·s or more.

By setting the viscosity of the polymerizable composition for forming the intermediate organic layer 18 at 25° C. to 1 Pa·s or more, the cissing of the polymerizable composition is prevented and thus a good intermediate organic layer 18 can be formed on the entire surface of the lower inorganic layer 16.

The protective organic layer 19 is formed on the second inorganic layer 16.

The protective organic layer 19 is provided as a preferable aspect, and even in a case where pressure and mechanical strength are applied to the barrier film 10, the protective organic layer protects the inorganic layer 16 and prevents damage to the inorganic layer 16.

As the protective organic layer 19, various layers exemplified in the above-described underlying organic layer 14 and layers exemplified in the intermediate organic layer 18 can be used.

In addition, in the protective organic layer 19, a polymer of a graft copolymer having an acrylic polymer as a main chain and at least one of a urethane polymer having an acryloyl group at a terminal or a urethane oligomer having an acryloyl group at the terminal as a side chain can also be used. As such a graft copolymer, commercially available products can be suitably used. Examples of commercially available products of the graft copolymer include ACRYD 8BR 930 manufactured by Taisei Fine Chemical Co., Ltd.

In addition, in a case where such a graft copolymer is used in the protective organic layer 19, at least one of trifunctional or higher functional (meth)acrylate or (meth)acrylate polymer is preferably used in combination. By forming the protective organic layer 19 using the graft copolymer and at least one of trifunctional or higher functional (meth)acrylate or (meth)acrylate polymer, a protective organic layer 19 having high hardness and excellent protection performance of the inorganic layer 16 can be formed.

Further, as the protective organic layer 19, a protective organic layer 19 containing a polymer of this graft copolymer, a polymer of (meth)acrylate represented by Formula (1), and a polymer of a graft copolymer and (meth)acrylate represented by Formula (1) can be suitably used.

That is, as the protective organic layer 19, a protective organic layer 19 formed with a polymerizable composition containing a polymer of this graft copolymer and (meth)acrylate represented by Formula (1) can be suitably used.

The thickness of the protective organic layer 19 may be appropriately set according to the forming material or the like so that the desired protective performance can be obtained.

According to the studies by the present inventors, the thickness of the protective organic layer 19 is preferably 0.5 to 5 μm and more preferably 1 to 3 μm.

The protective organic layer 19 can also be formed by a coating method using a polymerizable composition containing a solvent, an organic compound which becomes the protective organic layer 19, a surfactant, a silane coupling agent, a photopolymerization initiator, and the like, like other organic layers.

In addition, the protective organic layer 19 is also preferably formed by R to R.

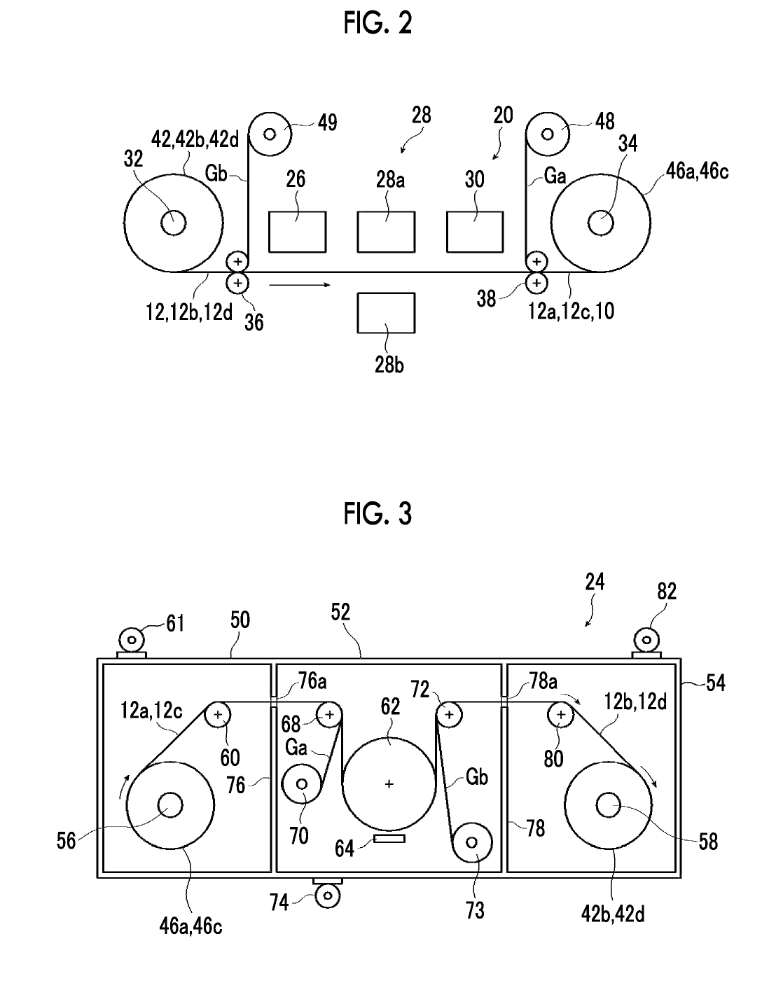

Hereinafter, an example of the method of producing a gas barrier film according to the embodiment of the present invention will be described with reference to the conceptual views of FIGS. 2 and 3.

An apparatus shown in FIG. 2 is an organic film forming apparatus 20 for forming an organic layer. The organic film forming apparatus 20 is for forming an organic layer by R to R, and while a long support (material for film formation) is transported in the longitudinal direction, the polymerizable composition which becomes an organic layer is applied and dried, and then the polymerizable composition is cured (an organic compound is polymerized (crosslinked)) by light irradiation to form the underlying organic layer 14 and the intermediate organic layer 18, and further the protective organic layer 19 on an inorganic layer 16.

The organic film forming apparatus 20 shown in the drawing has, for example, a coating unit 26, a drying unit 28, a light irradiation unit 30, a rotary shaft 32, a roll-up shaft 34, and pairs of transportation rollers 36 and 38.

On the other hand, an apparatus shown in FIG. 3 is an inorganic film forming apparatus 24 for forming an inorganic layer 16. The inorganic film forming apparatus 24 is for forming an inorganic layer 16 by R to R, and while the long support on which the organic layer is formed is transported in the longitudinal direction, the inorganic layer 16 is formed on the underlying organic layer 14, and, another inorganic layer 16 is formed on the intermediate organic layer 18.

The inorganic film forming apparatus 24 shown in the drawing has a supply chamber 50, a film formation chamber 52, and a roll-up chamber 54. The supply chamber 50 and the film formation chamber 52 are separated by a partition wall 76 having an opening 76a, and the film formation chamber 52 and the roll-up chamber 54 are separated by a partition wall 78 having an opening 78a, respectively.

In a case where the barrier film 10 is prepared, first, a material roll 42 that is formed by rolling up the long support 12 is loaded on the rotary shaft 32.

In a case where the material roll 42 is loaded on the rotary shaft 32, the support 12 is drawn from the material roll 42, and is allowed to pass through a predetermined transportation path which starts from the pair of transportation rollers 36, passes through the coating unit 26, the drying unit 28 and the light irradiation unit 30, and the pair of transportation rollers 38, and then reaches the roll-up shaft 34.

The support 12 drawn from the material roll 42 is transported to the coating unit 26 by the pair of transportation rollers 36, and the polymerizable composition for forming the underlying organic layer 14 is applied to the surface. The coating unit 26 applies the polymerizable composition for forming the underlying organic layer 14 so that the thickness of the underlying organic layer 14 with respect to the intermediate organic layer 18 to be formed later becomes a desired film thickness such that the ratio between the thickness of the intermediate organic layer 18 and the thickness of the underlying organic layer 14 is 0.1 or less.

The coating composition which becomes the underlying organic layer 14 includes an organic solvent, an organic compound which becomes the underlying organic layer 14, a surfactant, a silane coupling agent, a photopolymerization initiator, and the like as described above.

For the application of the polymerizable composition in the coating unit 26, various known coating methods such as a die coating method, a dip coating method, an air knife coating method, a curtain coating method, a roller coating method, a wire bar coating method, and a gravure coating method can be used.

The support 12 to which the polymerizable composition, which becomes the underlying organic layer 14, is applied is then heated by the drying unit 28 to dry the polymerizable composition.

The drying unit 28 has a drying section 28a which performs drying by heating from the front surface side (polymerizable composition side), and a drying section 28b which performs drying by heating from the rear surface side (support 12 side), and dries the polymerizable composition by heating from both the front surface side and the rear surface side.

The heating in the drying unit 28 may be performed by a known method of heating a sheet-like material. For example, the drying section 28a for drying from the front surface side is a warm air drying section, and the drying section 28b for drying from the rear surface side is a heat roller (pass roller with a heating mechanism).

Next, the support 12 on which the polymerizable composition, which becomes the underlying organic layer 14, is dried is irradiated with an ultraviolet ray in the light irradiation unit 30. By the irradiation with the ultraviolet ray, the polymerizable composition is cured (the organic compound is crosslinked (polymerized)) and the underlying organic layer 14 is formed. As necessary, the polymerizable compositions which become the underlying organic layer 14, the intermediate organic layer 18, and the protective organic layer 19 may be cured in an inert gas atmosphere such as a nitrogen atmosphere.

The support 12 on which the underlying organic layer 14 is formed is transported by the pair of transportation rollers 38 and is rolled up by the roll-up shaft 34 in a roll shape. In the following description, the support 12 on which the underlying organic layer 14 is formed is also referred to as “support 12a”.

Here, in the organic film forming apparatus 20, after the underlying organic layer 14 is formed, in the pair of transportation rollers 38, the protective film Ga fed from the supply roll 48 is laminated on the formed underlying organic layer 14 to protect the underlying organic layer 14.

As the protective film Ga and the protective film Gb described later, usually, films formed of polyolefins such as PE and PP are used.

Next, the support 12a is rolled up by the roll-up shaft 34. In a case where the underlying organic layer 14 having a predetermined length is formed, the support 12a is cut as necessary to form a material roll 46a obtained by rolling up the support 12a.

The material roll 46a that is obtained by rolling up the support 12a (the support 12 on which the underlying organic layer 14 is formed) is then supplied to the inorganic film forming apparatus 24 to form the first inorganic layer 16.

The material roll 46a supplied to the inorganic film forming apparatus 24 is loaded on the rotary shaft 56 of the supply chamber 50.

In a case where the material roll 46a is loaded on the rotary shaft 56, the support 12a is drawn from the material roll 46a, and is allowed to pass through a predetermined path which starts from the supply chamber 50, passes through film formation chamber 52 and then reaches the roll-up shaft 58 of the roll-up chamber 54.

After the support 12a is allowed to pass through the predetermined path, vacuum exhaust means 61 of the supply chamber 50, vacuum exhaust means 74 of the film formation chamber 52, and vacuum exhaust means 82 of the roll-up chamber 54 are driven and the pressure in the inorganic film forming apparatus 24 is set to a predetermined pressure.

After the inside of the inorganic film forming apparatus 24 reaches a predetermined pressure, the transportation of the support 12a is started. The support 12a fed from the material roll 46a is guided by a pass roller 60 and is transported to the film formation chamber 52.

The support 12a transported to the film formation chamber 52 is guided to a pass roller 68 and rolled around a drum 62. The support 12a is transported along the predetermined path while being supported by the drum 62, and the first inorganic layer 16 is formed by film formation means 64 by, for example, CCP-CVD. In a case where the inorganic layer 16 is formed, before the inorganic layer 16 is formed, the protective film Ga laminated on the underlying organic layer 14 in the pass roller 68 is peeled off and is collected by a collection roll 70.

The inorganic layer 16 may be formed by a film formation method according to a known vapor phase deposition method such as plasma CVD such as CCP-CVD and ICP-CVD, sputtering such as magnetron sputtering and reactive sputtering, and vacuum vapor deposition according to the inorganic layer 16 to be formed, which is as described above. Accordingly, a raw material gas (process gas) to be used, film formation conditions, and the like may be appropriately set and selected according to the inorganic layer 16 to be formed, film thickness, and the like.

The support 12a on which the inorganic layer 16 is formed is guided to a pass roller 72 and is transported to the roll-up chamber 54. In the following description, the support 12a on which the inorganic layer 16 is formed is referred to as “support 12b”.

Here, in the inorganic film forming apparatus 24, in the pass roller 72, the protective film Gb fed from the supply roll 73 is laminated on the inorganic layer 16 to protect the inorganic layer 16.

The support 12b transported to the roll-up chamber 54 is rolled up by the roll-up shaft 58.

In a case where the formation of the inorganic layer 16 is completed, cleaned dry air is introduced into all of the chambers of the inorganic film forming apparatus 24 and is released to the atmosphere. Then, the support 12b is cut as necessary to form a material roll 46b formed by rolling up the support 12b and taken out from the roll-up chamber 54 of the inorganic film forming apparatus 24.

The material roll 46b that is formed by rolling up the support 12b (the support 12 on which the underlying organic layer 14 and the inorganic layer 16 are formed) is supplied to the organic film forming apparatus 20 again to form the intermediate organic layer 18.

The material roll 46b that is formed by rolling up the support 12b is loaded on the rotary shaft 32 then the support 12b is drawn from the material roll 46b, and is allowed to pass through the predetermined transportation path to reach the roll-up shaft 34, as in the formation of the above underlying organic layer 14.

As in the formation of the underlying organic layer 14, in the organic film forming apparatus 20, while the support 12b is transported in the longitudinal direction, the polymerizable composition is applied to the inorganic layer 16 in the coating unit 26 for forming the intermediate organic layer 18.

In a case where the intermediate organic layer 18 is formed on the inorganic layer 16, before the polymerizable composition is applied, in the pair of transportation rollers 36, the protective film Gb laminated on the inorganic layer 16 is peeled off and is collected by the collection roll 49. In this case, there is a possibility that polyolefin peeled off from the protective film Gb may remain on the surface of the inorganic layer 16 as described above.

As described above, the polymerizable composition for forming the intermediate organic layer 18 is the (meth)acrylate represented by Formula (1), preferably at least one of urethane (meth)acrylate or (meth)acrylate having a double bond equivalent of 200 or less, and further, a composition obtained by dissolving or dispersing a silane coupling agent, a photopolymerization initiator, and the like in a solvent as necessary.

The coating unit 26 applies the polymerizable composition so that the film thickness of the intermediate organic layer 18 to be formed is 0.05 to 0.5 μm as desired.

Next, in the drying unit 28, the polymerizable composition is heated and dried. Here, the polymerizable composition for forming the intermediate organic layer 18 contains (meth)acrylate represented by Formula (1), and preferably contains at least one of urethane (meth)acrylate or (meth)acrylate having a double bond equivalent of 200 or less. Therefore, the polymerizable composition maintains sufficient viscosity even in a state of being heated for drying.

Accordingly, as described above, the film thickness of the intermediate organic layer 18 to be formed is 0.05 to 0.5 μm and is very thin, and further, even in a case where polyolefin peeled off from the protective film Ga remains on the surface of the inorganic layer 16, the cissing of the polymerizable composition does not occur and the polymerizable composition for forming the intermediate organic layer 18 can be appropriately dried while covering the entire surface of the inorganic layer 16.

The support 12b on which the polymerizable composition for forming the intermediate organic layer 18 is dried is then irradiated with an ultraviolet ray or the like in the light irradiation unit 30 and the polymerizable composition is cured to form the intermediate organic layer 18. In the following description, the support 12b on which the intermediate organic layer 18 is formed is referred to as “support 12c”.

The support 12c is rolled up by the roll-up shaft 34 in a roll shape. As in the formation of the underlying organic layer 14, in the organic film forming apparatus 20, in the pair of transportation rollers 38, the protective film Ga fed from the supply roll 48 is laminated on the formed intermediate organic layer 18 to protect the intermediate organic layer 18.

In a case where the formation of the intermediate organic layer 18 having a predetermined length is completed, in the same manner as above, the support 12c is cut as necessary to form a material roll 46c that is obtained by rolling up the support 12c.

The material roll 46c that is obtained by rolling up the support 12c (the support 12 on which the underlying organic layer 14, the inorganic layer 16, and the intermediate organic layer 18 are formed) is supplied to the inorganic film forming apparatus 24 shown in FIG. 3 again to form the second inorganic layer 16.

In the inorganic film forming apparatus 24, the material roll 46c is loaded on the rotary shaft 56 of the supply chamber 50 in the same manner as above.

In a case where the material roll 46c is loaded on the rotary shaft 56, the support 12c is drawn from the material roll 46c, and is allowed to pass through the predetermined path which starts from the supply chamber 50, passes through the film formation chamber 52, and reaches the roll-up shaft 58 of the roll-up chamber 54. After the support 12c passes through the predetermined path, in the same manner as above, the pressure of each chamber is set to a predetermined pressure and the transportation of the support 12c is started.

While the support 12c is transported along the predetermined path, in the film formation chamber 52, the protective film Ga is peeled off, the second inorganic layer 16 is formed on the intermediate organic layer 18, and the protective film Gb is laminated on the formed inorganic layer 16 in the same manner as above. The support 12c on which the second inorganic layer 16 is formed is transported to the roll-up chamber 54 and is rolled up by the roll-up shaft 58. In the following description, the support 12c on which the second inorganic layer 16 is formed is referred to as “support 12d”.

In a case where the formation of the second inorganic layer 16 is completed, in the same manner as above, the inorganic film forming apparatus 24 is released to the atmosphere. Then, the support 12d is cut as necessary to form a material roll 42d that is formed by rolling up the support 12d and taken out from the roll-up chamber 54.

The material roll 42d that is obtained by rolling up the support 12d is supplied to the organic film forming apparatus 20 again to form the protective organic layer 19.

As described above, in a case where three or more combinations of an organic layer which becomes an underlying base and an inorganic layer is formed, that is, in a case where two or more combinations of the intermediate organic layer 18 and the inorganic layer 16 is provided, the formation of the intermediate organic layer 18 and the inorganic layer 16 may be repeatedly performed according to the number of combinations of the intermediate organic layer 18 and the inorganic layer 16 to be formed.

The material roll 42d that is obtained by rolling up the support 12d (the support 12 on which the underlying organic layer 14, the inorganic layer 16, the intermediate organic layer 18, and the inorganic layer 16 are formed) is loaded on the rotary shaft 32, and then the support 12d is drawn and is allowed to pass through the predetermined transportation path to reach the roll-up shaft 34 in the same manner as above.

While the support 12d is transported along the predetermined path, first, the protective film Gb is peeled off in the pair of transportation rollers 36, and the polymerizable composition which becomes the protective organic layer 19 is applied to the second inorganic layer 16 in the coating unit 26 in the same manner as above. As described above, the coating composition which becomes the protective organic layer 19 includes an organic solvent, an organic compound which becomes the protective organic layer 19, a surfactant, a silane coupling agent, a photopolymerization initiator, and the like.

Next, the polymerizable composition which becomes the protective organic layer 19 on the support 12d to which the polymerizable composition is applied is dried in the drying unit 28 and is further irradiated with an ultraviolet ray or the like in the light irradiation unit 30, and the polymerizable composition which becomes the protective organic layer 19 is cured to form the protective organic layer 19.

The support 12d on which the protective organic layer 19 is formed, that is, the barrier film 10 is rolled up by the roll-up shaft 34 in a roll shape.

The gas barrier film and the method of producing the gas barrier film according to the embodiments of the present invention have been described in detail, but the present invention is not limited to the above examples, and may be improved or modified in various ways within a range that does not depart from the gist of the present invention.

### EXAMPLES

Hereinafter, the present invention will be described in more detail based on specific examples of the present invention.

### Example 1

«Support»

As the support 12, a PET film having a width of 1000 mm, a thickness of 100 μm, and a length of 100 m (COSMO SHINE A4300 manufactured by Toyobo Co., Ltd.) was used.

«Formation of Underlying Organic Layer 14»

TMPTA (manufactured by Daicel-Cytec Co., Ltd.) and a photopolymerization initiator (ESACURE KTO 46 manufactured by Lamberti S.p.A.) were prepared and weighed such that the mass ratio thereof was 95:5. These were dissolved in methyl ethyl ketone (MEK) such that the concentration of the solid content was 15% by mass, thereby preparing a polymerizable composition for forming the underlying organic layer 14.

The polymerizable composition for forming the underlying organic layer 14 was loaded in a predetermined position of the coating unit 26 of the organic film forming apparatus 20 shown in FIG. 2. In addition, the material roll 42 formed by rolling up the support 12 in a roll shape was loaded on rotary shaft 32 and the support 12 was inserted through a predetermined transportation path. Further, the supply roll 48 formed by rolling up the protective film Ga formed of PE was loaded in a predetermined position and the protective film was laminated on the underlying organic layer 14 in the pair of transportation rollers 38.

In the organic film forming apparatus 20, while the support 12 was transported in the longitudinal direction, in the coating unit 26, the polymerizable composition was applied and in the drying unit 28, the polymerizable composition was dried. For the coating unit 26, a die coater was used. The heating temperature in the drying unit 28 was set to 50° C. and the pass time was set to 3 minutes.

Thereafter, in the light irradiation unit 30, the polymerizable composition was irradiated with an ultraviolet ray (cumulative irradiation dose: about 600 mJ/cm²) and cured to form the underlying organic layer 14. In the pair of transportation rollers 38, after the protective film Ga was laminated on the surface of the underlying organic layer 14, the support was rolled up and the support 12 on which the underlying organic layer 14 was formed (the support 12a) was rolled up to form the material roll 46a. The thickness of the underlying organic layer 14 was 5 μm (5000 nm).

«Formation of First Inorganic Layer 16»

The material roll 46a formed by rolling up the support 12a (the support 12 on which the underlying organic layer 14 was formed) was loaded on the rotary shaft 56 of the supply chamber 50 of the inorganic film forming apparatus 24 for performing film formation shown in FIG. 3 by CCP-CVD, and the support 12a was allowed to pass through a predetermined transportation path. In addition, the supply roll 73 formed by rolling up the protective film Gb formed of PE was loaded in a predetermined position and in the pass roller 72, and the protective film was laminated on the inorganic layer 16.

In the inorganic film forming apparatus 24, while the support 12a was transported in the longitudinal direction, in the film formation chamber 52, the protective film Ga was peeled off in the pass roller 68, and then a silicon nitride film was formed on the underlying organic layer 14 as the inorganic layer 16. Next, after the protective film Gb was laminated on the surface of the inorganic layer 16 in the pass roller 72, the support was rolled up by the roll-up shaft 58 in the roll-up chamber 54 to form the material roll 42b formed by rolling up the support 12a on which the inorganic layer 16 was formed (support 12b).

As raw material gases for forming the inorganic layer 16, silane gas (flow rate: 160 sccm), ammonia gas (flow rate: 370 sccm), hydrogen gas (flow rate: 590 sccm), and nitrogen gas (flow rate: 240 sccm) were used. As a power supply, a high-frequency power supply having a frequency of 13.56 MHz was used, and a plasma excitation electric power was set to 800 W. The film forming pressure was set to 40 Pa. The achieved film thickness of the inorganic layer 16 was 35 nm.

«Formation of Intermediate Organic Layer 18»

As the (meth)acrylate represented by Formula (1), a compound EA below was prepared.

Compound EA (NK OLIGO EA-8720 manufactured by Shin Nakamura Chemical Co., Ltd.)

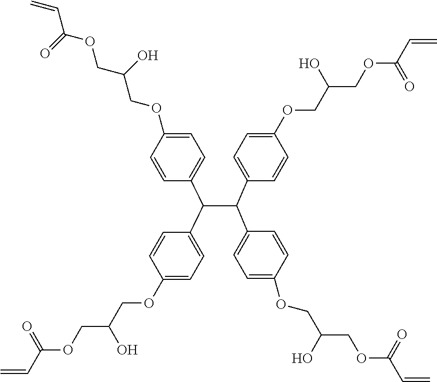 [SMILES: C=CC(=O)OCC(O)COc1ccc(C(c2ccc(OCC(O)COC(=O)C=C)cc2)C(c2ccc(OCC(O)COC(=O)C=C)cc2)c2ccc(OCC(O)COC(=O)C=C)cc2)cc1]

The compound EA, a silane coupling agent (KBM5103 manufactured by Shin-Etsu Silicone Co., Inc.), and a photopolymerization initiator (ESACURE KT046 manufactured by Lamberti S.p.A.) were prepared and weighed such that the mass ratio of compound EA:silane coupling agent:photopolymerization initiator was 87:10:3. These were dissolved in a mixed solvent of MEK and propylene glycol monomethyl ether acetate (PGMEA) (MEK:PGMEA=4:6) such that the concentration of the solid content was 5% by mass, thereby preparing a polymerizable composition for forming the intermediate organic layer 18.

The polymerizable composition for forming the intermediate organic layer 18 was loaded in a predetermined position of the coating unit 26 organic film forming apparatus 20 shown in FIG. 2 using R to R. In addition, the material roll 42b formed by rolling up the support 12b was loaded on the rotary shaft 32 and the support 12b was inserted through a predetermined transportation path. Further, the supply roll 48 formed by rolling up the protective film Ga formed of PE was loaded in a predetermined position and the protective film was laminated on the intermediate organic layer 18 in the pair of transportation rollers 38.

In the organic film forming apparatus 20, while the support 12b (the support 12 on which the underlying organic layer 14 and the inorganic layer 16 were formed) was transported in the longitudinal direction, the polymerizable composition was applied by the coating unit 26, and the polymerizable composition was dried in the drying unit 28. For the coating unit 26, a die coater was used. The drying temperature in the drying unit 28 was set to 110° C. and the passing time was set to 3 minutes.

Thereafter, while heating at 80° C. from the support 12 side, the polymerizable composition was irradiated with an ultraviolet ray in the light irradiation unit 30 (cumulative irradiation dose: about 600 mJ/cm²) and was cured to form the intermediate organic layer 18. In the pair of transportation rollers 38, after the protective film Ga was laminated on the surface of the intermediate organic layer 18, the support was rolled up and the support 12b on which the intermediate organic layer 18 was formed (the support 12c) was rolled up to form the material roll 46c. The thickness of the intermediate organic layer 18 was 0.15 μm (150 nm).

«Formation of Second Inorganic Layer 16»

The material roll 46c formed by rolling up the support 12c (the support 12 on which the underlying organic layer 14, the inorganic layer 16, and the intermediate organic layer 18 were formed) was loaded on the rotary shaft 56 of the supply chamber 50 of the inorganic film forming apparatus 24 shown in FIG. 3 and was inserted through a predetermined path.

Next, as in the first inorganic layer 16, the second inorganic layer 16 was formed on the intermediate organic layer 18 to prepare a gas barrier film. The achieved film thickness of the inorganic layer was 35 nm.

### Example 2

A gas barrier film was prepared in the same manner as in Example 1 except that in the formation of the intermediate organic layer 18, the amount of the polymerizable composition applied for forming the intermediate organic layer 18 was changed, and the film thickness of the intermediate organic layer 18 was changed to 0.5 μm (500 nm).

### Example 3

A gas barrier film was prepared in the same manner as in Example 1 except that in the formation of the intermediate organic layer 18, the amount of the polymerizable composition applied for forming the intermediate organic layer 18 was changed, and the film thickness of the intermediate organic layer 18 was changed to 0.05 μm (50 nm).

### Example 4

A gas barrier film was prepared in the same manner as in Example 1 except that in the formation of the underlying organic layer 14, the amount of the polymerizable composition applied for forming the underlying organic layer 14 was changed and the film thickness of the underlying organic layer 14 was changed to 3 μm (3000 nm).

### Example 5

A gas barrier film was prepared in the same manner as in Example 1 except that in the formation of the underlying organic layer 14, the amount of the polymerizable composition applied for forming the underlying organic layer 14 was changed, and the film thickness of the underlying organic layer 14 was changed to 3 μm (3000 nm), and further, in the formation of the intermediate organic layer 18, the amount of the polymerizable composition applied for forming the intermediate organic layer 18 was changed, and the film thickness of the intermediate organic layer 18 was changed to 0.3 μm (300 nm).

### Example 6

As urethane (meth)acrylate, ACRYD 8BR 600 manufactured by Taisei Fine Chemical Co., Ltd. was prepared.

A polymerizable composition for forming the intermediate organic layer 18 was prepared in the same manner as in Example 1 except that the urethane (meth)acrylate was further added to the polymerizable composition for forming the intermediate organic layer 18, and each material was weighed such that the mass ratio of compound EA:urethane (meth)acrylate:silane coupling agent:photopolymerization initiator was 85:2:10:3.

A gas barrier film was prepared in the same manner as in Example 1 except that this polymerizable composition was used to form the intermediate organic layer 18.

### Example 7

As urethane (meth)acrylate, ACRYD 8DK 2030 manufactured by Taisei Fine Chemical Co., Ltd. was prepared.

A polymerizable composition for forming the intermediate organic layer 18 was prepared in the same manner as in Example 6 except that as the urethane (meth)acrylate, instead of ACRYD 8BR 600, this ACRYD 8DK 2030 was used.

A gas barrier film was prepared in the same manner as in Example 1 except that this polymerizable composition was used to form the intermediate organic layer 18.

### Example 8

As urethane (meth)acrylate, U-6LPA manufactured by Shin Nakamura Chemical Co., Ltd. was prepared.

A polymerizable composition for forming the intermediate organic layer 18 was prepared in the same manner as in Example 6 except that as the urethane (meth)acrylate, instead of ACRYD 8BR 600, the U-6LPA was used.

A gas barrier film was prepared in the same manner as in Example 1 except that this polymerizable composition was used to form the intermediate organic layer 18.

### Example 9

As urethane (meth)acrylate, U-6HA manufactured by Shin Nakamura Chemical Co., Ltd. was prepared.

A polymerizable composition for forming the intermediate organic layer 18 was prepared in the same manner as in Example 6 except that as the urethane (meth)acrylate, instead of ACRYD 8BR 600, the U-6HA was used.

A gas barrier film was prepared in the same manner as in Example 1 except that this polymerizable composition was used to form the intermediate organic layer 18.

### Example 10

As urethane (meth)acrylate, U-15HA manufactured by Shin Nakamura Chemical Co., Ltd. was prepared.

A polymerizable composition for forming the intermediate organic layer 18 was prepared in the same manner as in Example 6 except that as the urethane (meth)acrylate, instead of ACRYD 8BR 600, the U-15HA was used.

A gas barrier film was prepared in the same manner as in Example 1 except that this polymerizable composition was used to form the intermediate organic layer 18.

### Example 11

A polymerizable composition for forming the intermediate organic layer 18 was prepared in the same manner as in Example 6 except that in the preparation of the polymerizable composition, the components were weighed such that the mass ratio of compound EA:urethane (meth)acrylate:silane coupling agent: photopolymerization initiator was 82:5:10:3.

A gas barrier film was prepared in the same manner as in Example 1 except that this polymerizable composition was used to form the intermediate organic layer 18.

### Example 12

A polymerizable composition for forming the intermediate organic layer 18 was prepared in the same manner as in Example 6 except that in the preparation of the polymerizable composition, the components were weighed such that the mass ratio of compound EA:urethane (meth)acrylate:silane coupling agent: photopolymerization initiator was 77:10:10:3.

A gas barrier film was prepared in the same manner as in Example 1 except that this polymerizable composition was used to form the intermediate organic layer 18.

### Example 13

As urethane (meth)acrylate, ACRYD 8BR 600 manufactured by Taisei Fine Chemical Co., Ltd. was prepared.

In addition, as (meth)acrylate having a double bond equivalent of 200 or less, TMPTA (manufactured by Daicel-Cytec Co., Ltd.) was used.

A polymerizable composition for forming the intermediate organic layer 18 was prepared in the same manner as in Example 1 except that the urethane (meth)acrylate and the (meth)acrylate were added to the polymerizable composition for forming the intermediate organic layer 18 and further the components were weighed such that the mass ratio of compound EA:(meth)acrylate:urethane (meth)acrylate:silane coupling agent: photopolymerization initiator was 75:10:2:10:3.

A gas barrier film was prepared in the same manner as in Example 1 except that this polymerizable composition was used to form the intermediate organic layer 18.

### Example 14

As (meth)acrylate having a double bond equivalent of 200 or less, DPHA (A-DPH manufactured by Shin Nakamura Chemical Co., Ltd.) was prepared.

A polymerizable composition for forming the intermediate organic layer 18 was prepared in the same manner as in Example 13 except that as the (meth)acrylate having a double bond equivalent of 200 or less, instead of TMPTA, DPHA was used.

A gas barrier film was prepared in the same manner as in Example 1 except that this polymerizable composition was used to form the intermediate organic layer 18.

### Example 15

A gas barrier film the same as the gas barrier film in Example 1 was prepared. In addition, the polymerizable composition used for forming the intermediate organic layer 18 in Example 6 was prepared.

The protective organic layer 19 was formed on the second inorganic layer 16 of the gas barrier film in the same manner as in the formation of the intermediate organic layer 18 in Example 6 except that the polymerizable composition was used and the amount of the polymerizable composition applied was changed and the gas barrier film 10 shown in FIG. 1 was prepared. The thickness of the protective organic layer 19 was 1 μm (1000 nm).

### Example 16

A gas barrier film was prepared in the same manner as in Example 1. The second intermediate organic layer 18 was formed on the second inorganic layer 16 of the gas barrier film in the same manner as in the formation of the intermediate organic layer 18 formed in advance.

On the second intermediate organic layer 18, in the same manner as in the formation of the inorganic layer 16 formed in advance, a third inorganic layer was formed. Thus, a gas barrier film having three combinations of an organic layer which becomes an underlying base and an inorganic layer was prepared.

### Example 17

A gas barrier film was prepared in the same manner as in Example 6. That is, the polymerizable composition for forming the intermediate organic layer 18 in the gas barrier film contains urethane (meth)acrylate (ACRYD 8BR 600) in addition to the compound EA.

On the second inorganic layer 16 of the gas barrier film, in the same manner as in the formation of the intermediate organic layer 18 formed in advance, the second intermediate organic layer 18 was formed.

On the second intermediate organic layer 18, in the same manner as in the formation of the inorganic layer 16 formed in advance, a third inorganic layer was formed. Thus, a gas barrier film having three combinations of an organic layer which becomes an underlying base and an inorganic layer was prepared.

### Comparative Example 1

A gas barrier film was prepared in the same manner as in Example 1 except that in the formation of the underlying organic layer 14, the amount of the polymerizable composition applied for forming the underlying organic layer 14 was changed, and the film thickness of the underlying organic layer 14 was changed to 6 μm (6000 nm), and further, in the formation of the intermediate organic layer 18, the amount of the polymerizable composition applied for forming the intermediate organic layer 18 was changed, and the film thickness of the intermediate organic layer 18 was changed to 0.6 μm (600 nm).

### Comparative Example 2

A gas barrier film was prepared in the same manner as in Example 1 except that in the formation of the intermediate organic layer 18, the amount of the polymerizable composition applied for forming the intermediate organic layer 18 was changed, and the film thickness of the intermediate organic layer 18 was changed to 0.02 μm (20 nm).

### Comparative Example 3

A gas barrier film was prepared in the same manner as in Example 1 except that in the formation of the underlying organic layer 14, the amount of the polymerizable composition applied for forming the underlying organic layer 14 was changed, and the film thickness of the underlying organic layer 14 was changed to 1.8 μm (1800 nm), and further, in the formation of the intermediate organic layer 18, the amount of the polymerizable composition applied for forming the intermediate organic layer 18 was changed, and the film thickness of the intermediate organic layer 18 was changed to 0.4 μm (400 nm).

### Comparative Example 4

A polymerizable composition for forming the intermediate organic layer 18 was prepared in the same manner as in Example 1 except that in the preparation of the polymerizable composition for forming the intermediate organic layer 18, instead of the compound EA, TMPTA (manufactured by Daicel-Cytec Co., Ltd.) was used.

A gas barrier film was prepared in the same manner as in Example 1 except that this polymerizable composition was used to form the intermediate organic layer 18.

### Comparative Example 5

A polymerizable composition for forming the intermediate organic layer 18 was prepared in the same manner as in Example 1 except that in the preparation of the polymerizable composition for forming the intermediate organic layer 18, instead of the compound EA, DPHA (A-DPH manufactured by Shin Nakamura Chemical Co., Ltd.) was used.

A gas barrier film was prepared in the same manner as in Example 1 except that this polymerizable composition was used to form the intermediate organic layer 18.

[Evaluation]

Regarding the gas barrier films prepared as described above, gas barrier properties and adhesiveness were evaluated.

<Gas Barrier Properties>

The water vapor transmission rate [g/(m²·day)] was measured by the calcium corrosion method (the method described in JP2005-283561A) under conditions of a temperature of 40° C. and a relative humidity of 90% RH.

The measurement of the water vapor transmission rate was performed immediately after the gas barrier films were prepared and after the gas barrier films were left to stand for 500 hours in an environment at a temperature of 85° C. and a relative humidity of 85% RH.

<Adhesiveness>

Evaluation was performed with a cross-cut peel test in accordance with JIS K 5400. The film formation surface of the protective organic layer 19 of each of the gas barrier films was cut at an angle of 90° to the film surface an intervals of 1 mm using a cutter knife, thereby forming 100 cross cuts at intervals of 1 mm. A 2 cm wide Mylar Tape (manufactured by Nitto Denko Corporation, polyester tape No. 31B) was attached to the surface and the tape was peeled off The number of grids on which the protective organic layer 19 remained was used for evaluation.

The cross-cut peel test was performed immediately after the gas barrier films were prepared and after the gas barrier films were left to stand for 500 hours in an environment at a temperature 85° C. and a relative humidity of 85% RH.

The results are shown in the following tables.

TABLE 1

| | | | | |
|---|---|---|---|---|
| Example 1 | Example 2 | Example 3 | Example 4 | Example 5 |

Protective organic layer
Inorganic layer (Third layer)

| Intermediate | Main component | | | | | | | | | | |
|---|---|---|---|---|---|---|---|---|---|---|---|
| organic layer | Urethane | | | | | | | | | | |
| (Second layer) | (meth)acrylate | | | | | | | | | | |
| | (Meth)acrylate | | | | | | | | | | |
| Inorganic layer (Second layer) | | 35 nm | | 35 nm | | 35 nm | | 35 nm | | 35 nm | |
| Intermediate | Main component | EA | 150 nm | EA | 500 nm | EA | 50 nm | EA | 150 nm | EA | 300 nm |
| organic layer | Urethane | | | | | | | | | | |
| (First layer) | (meth)acrylate | | | | | | | | | | |
| | (Meth)acrylate | | | | | | | | | | |

| Inorganic layer (First layer) | | 35 nm | 35 nm | 35 nm | 35 nm | 35 nm |
|---|---|---|---|---|---|---|
| Underlying organic layer | | 5000 nm | 5000 nm | 5000 nm | 3000 nm | 3000 nm |
| Ratio between thickness of | | 0.03 | 0.1 | 0.01 | 0.05 | 0.1 |
| intermediate organic layer/thickness | | | | | | |
| of underlying organic layer | | | | | | |
| Water vapor | Immediately after | 1.3 × 10⁻⁵ | 1.1 × 10⁻⁵ | 1.6 × 10⁻⁵ | 3.6 × 10⁻⁵ | 2.9 × 10⁻⁵ |
| transmission | preparation | | | | | |
| rate | Immediately after | 1.4 × 10⁻⁵ | 1.2 × 10⁻⁵ | 1.7 × 10⁻⁵ | 3.8 × 10⁻⁵ | 3.1 × 10⁻⁵ |
| [g/(m² · day)] | being left to stand | | | | | |
| | under high | | | | | |
| | temperature and high | | | | | |
| | humidity condition | | | | | |
| Adhesiveness | Immediately after | 100/100 | 80/100 | 100/100 | 100/100 | 90/100 |
| [Number of | preparation | | | | | |
| remaining | Immediately after | 90/100 | 70/100 | 100/100 | 90/100 | 95/100 |
| grids] | being left to stand | | | | | |
| | under high | | | | | |
| | temperature and high | | | | | |
| | humidity condition | | | | | |

TABLE 2

| | | | | |
|---|---|---|---|---|
| Example 6 | Example 7 | Example 8 | Example 9 | Example 10 |

Protective organic layer
Inorganic layer (Third layer)

| Intermediate | Main component | | | | | | | | | | |
|---|---|---|---|---|---|---|---|---|---|---|---|
| organic layer | Urethane | | | | | | | | | | |
| (Second layer) | (meth)acrylate | | | | | | | | | | |
| | (Meth)acrylate | | | | | | | | | | |
| Inorganic layer (Second layer) | | 35 nm | | 35 nm | | 35 nm | | 35 nm | | 35 nm | |
| Intermediate | Main component | EA | 150 nm | EA | 150 nm | EA | 150 nn | EA | 150 nm | EA | 150 nm |
| organic layer | Urethane | 8BR 600 | | 8DK 2030 | | U-6LPA | | U-6HA | | U-15HA | |
| (First layer) | (meth)acrylate | | | | | | | | | | |
| | (Meth)acrylate | | | | | | | | | | |

| Inorganic layer (First layer) | | 35 nm | 35 nm | 35 nm | 35 nm | 35 nm |
|---|---|---|---|---|---|---|
| Underlying organic layer | | 5000 nm | 5000 nm | 5000 nm | 5000 nm | 5000 nm |
| Ratio between thickness of | | 0.03 | 0.03 | 0.03 | 0.03 | 0.03 |
| intermediate organic layer/thickness | | | | | | |
| of underlying organic layer | | | | | | |
| Water vapor | Immediately after | 8 × 10⁻⁶ | 8.9 × 10⁻⁶ | 8.4 × 10⁻⁶ | 9.1 × 10⁻⁶ | 8.7 × 10⁻⁶ |
| transmission | preparation | | | | | |
| rate | Immediately after | 8.4 × 10⁻⁶ | 9.1 × 10⁻⁶ | 8.6 × 10⁻⁶ | 9.2 × 10⁻⁶ | 8.9 × 10⁻⁶ |
| [g/(m² · day)] | being left to stand | | | | | |
| | under high | | | | | |
| | temperature and high | | | | | |
| | humidity condition | | | | | |
| Adhesiveness | Immediately after | 100/100 | 100/100 | 100/100 | 100/100 | 100/100 |
| [Number of | preparation | | | | | |
| remaining | Immediately after | 100/100 | 100/100 | 100/100 | 100/100 | 100/100 |
| grids] | being left to stand | | | | | |
| | under high | | | | | |
| | temperature and high | | | | | |
| | humidity condition | | | | | |

The mass ratio of the main component and urethane (meth)acrylate in Examples 6 to 10 is 85:2.

TABLE 3

| | | Example 11 | | Example 12 | | Example 13 | | Example 14 | | Example 15 | |
|---|---|---|---|---|---|---|---|---|---|---|---|
| Protective organic layer | | | | | | | | | | 1000 nm | |
| Inorganic layer (Third layer) | | | | | | | | | | | |
| Intermediate | Main component | | | | | | | | | | |
| organic layer | Urethane | | | | | | | | | | |
| (Second layer) | (meth)acrylate | | | | | | | | | | |
| | (Meth)acrylate | | | | | | | | | | |
| Inorganic layer (Second layer) | | 35 nm | | 35 nm | | 35 nm | | 35 nm | | 35 nm | |
| Intermediate | Main component | EA | 150 nm | EA | 150 nm | EA | 150 nm | EA | 150 nm | EA | 150 nm |
| organic layer | Urethane | 8BR 600 | | 8BR 600 | | 8BR 600 | | 8BR 600 | | 8BR 600 | |
| (First layer) | (meth)acrylate | | | | | | | | | | |
| | (Meth)acrylate | | | | | TMPTA | | DPHA | | | |

| Inorganic layer (First layer) | | 35 nm | 35 nm | 35 nm | 35 nm | 35 nm |
|---|---|---|---|---|---|---|
| Underlying organic layer | | 5000 nm | 5000 nm | 5000 nm | 5000 nm | 5000 nm |
| Ratio between thickness of | | 0.03 | 0.03 | 0.03 | 0.03 | 0.03 |
| intermediate organic layer/thickness | | | | | | |
| of underlying organic layer | | | | | | |
| Water vapor | Immediately after | 9.4 × 10⁻⁶ | 1 × 10⁻⁵ | 7.9 × 10⁻⁶ | 7.9 × 10⁻⁶ | 7.2 × 10⁻⁶ |
| transmission | preparation | | | | | |
| rate | Immediately after | 1 × 10⁻⁵ | 1.5 × 10⁻⁵ | 8.3 × 10⁻⁶ | 8 × 10⁻⁶ | 7.4 × 10⁻⁶ |
| [g/(m² ·day)] | being left to stand | | | | | |
| | under high | | | | | |
| | temperature and high | | | | | |
| | humidity condition | | | | | |
| Adhesiveness | Immediately after | 100/100 | 100/100 | 100/100 | 100/100 | 100/100 |
| [Number of | preparation | | | | | |
| remaining | Immediately after | 100/100 | 100/100 | 100/100 | 100/100 | 100/100 |
| grids] | being left to stand | | | | | |
| | under high | | | | | |
| | temperature and high | | | | | |
| | humidity condition | | | | | |

The mass ratio of the main component and urethane (meth)acrylate in Example 11 is 85:2.

The mass ratio of the main component and urethane (meth)acrylate in Example 12 is 77:10.

TABLE 4

| Protective organic layer | | Example 16 | | Example 17 | |
|---|---|---|---|---|---|
| Inorganic layer (Third layer) | | 35 nm | | 35 nm | |
| Intermediate organic layer | Main component | EA | 150 nm | EA | 150 nm |
| (Second layer) | Urethane (meth)acrylate | | | 8BR 600 | |
| | (Meth)acrylate | | | | |
| Inorganic layer (Second layer) | | 35 nm | | 35 nm | |
| Intermediate organic layer | Main component | EA | 150 nm | EA | 150 nm |
| (First layer) | Urethane (meth)acrylate | | | 8BR 600 | |
| | (Meth)acrylate | | | | |

| Inorganic layer (First layer) | | 35 nm | 35 nm |
|---|---|---|---|
| Underlying organic layer | | 5000 nm | 5000 nm |
| Ratio between thickness of intermediate organic | | 0.03 | 0.03 |
| layer/thickness of underlying organic layer | | | |
| Water vapor transmission | Immediately after preparation | 6 × 10⁻⁶ | 5.8 × 10⁻⁶ |
| rate [g/(m² · day)] | Immediately after being left to | 6.1 × 10⁻⁶ | 5.9 × 10⁻⁶ |
| | stand under high temperature | | |
| | and high humidity condition | | |
| Adhesiveness | Immediately after preparation | 90/100 | 100/100 |
| [Number of remaining | Immediately after being left to | 80/100 | 100/100 |
| grids] | stand under high temperature | | |
| | and high humidity condition | | |

TABLE 5

| | | | | |
|---|---|---|---|---|
| Comparative | Comparative | Comparative | Comparative | Comparative |
| Example 1 | Example 2 | Example 3 | Example 4 | Example 5 |

Protective organic layer
Inorganic layer (Third layer)

| Intermediate | Main component | | | | | | | | | | |
|---|---|---|---|---|---|---|---|---|---|---|---|
| organic layer | Urethane | | | | | | | | | | |
| (Second layer) | (meth)acrylate | | | | | | | | | | |
| | (Meth)acrylate | | | | | | | | | | |
| Inorganic layer (Second layer) | | 35 nm | | 35 nm | | 35 nm | | 35 nm | | 35 nm | |
| Intermediate | Main component | EA | 600 nm | EA | 20 nm | EA | 400 nm | TMPTA | 150 nm | DPHA | 150 nm |
| organic layer | Urethane | | | | | | | | | | |
| (First layer) | (meth)acrylate | | | | | | | | | | |
| | (Meth)acrylate | | | | | | | | | | |

| Inorganic layer (First layer) | | 35 nm | 35 nm | 35 nm | 35 nm | 35 nm |
|---|---|---|---|---|---|---|
| Underlying organic layer | | 6000 nm | 5000 nm | 1800 nm | 5000 nm | 5000 nm |
| Ratio between thickness of | | 0.1 | 0.004 | 0.22 | 0.03 | 0.03 |
| intermediate organic layer/thickness | | | | | | |
| of underlying organic layer | | | | | | |
| Water vapor | Immediately after | 7.1 × 10⁻⁶ | 1.4 × 10⁻⁴ | 8.4 × 10⁻⁴ | 5.1 × 10⁻⁴ | 4.7 × 10⁻⁴ |
| transmission | preparation | | | | | |
| rate | Immediately after | 7.2 × 10⁻⁶ | 1.8 × 10⁻⁴ | 8.9 × 10⁻⁴ | 5.3 × 10⁻⁴ | 5.2 × 10⁻⁴ |
| [g/(m² · day)] | being left to stand | | | | | |
| | under high | | | | | |
| | temperature and high | | | | | |
| | humidity condition | | | | | |
| Adhesiveness | Immediately after | 20/100 | 100/100 | 100/100 | 0/100 | 0/100 |
| [Number of | preparation | | | | | |
| remaining | Immediately after | 10/100 | 100/100 | 95/100 | 0/100 | 0/100 |
| grids] | being left to stand | | | | | |
| | under high | | | | | |
| | temperature and high | | | | | |
| | humidity condition | | | | | |

As shown in the above tables, all of the gas barrier films of the present invention have excellent gas barrier properties and high adhesiveness. In particular, in Examples 6 to 10 in which the intermediate organic layer contains urethane (meth)acrylate in addition to the (meth)acrylate represented by Formula (1), further excellent gas barrier properties and adhesiveness are obtained. In Examples 13 and 14 in which the intermediate organic layer contains (meth)acrylate having a double bond equivalent of 200 or less, further excellent gas barrier properties are obtained. In addition, in Example 15 in which the protective organic layer 19 is provided, and Examples 16 and 17 in which three combinations of an organic layer which becomes an underlying base and an inorganic layer are provided, further excellent gas barrier properties and adhesiveness are obtained.

In contrast, in Comparative Example 1 in which the thickness of the intermediate organic layer is excessively thick, the gas barrier properties are good but the adhesiveness is low. On the other hand, in Comparative Example 2 in which the thickness of the intermediate organic layer is excessively thin, the adhesiveness is good but the gas barrier properties are low. In addition, in Comparative Example 3 in which the ratio between the thickness of the intermediate organic layer and the thickness of the underlying organic layer is more than 0.1, the adhesiveness is good, but the gas barrier properties are low. Further, in Comparative Examples 4 and 5 in which the intermediate organic layer does not contain the (meth)acrylate represented by Formula (1), the intermediate organic layer cannot be appropriately formed due to the cissing of the polymerizable composition, and the gas barrier properties and the adhesiveness are low.

From the above results, the effects of the present invention are apparent.

The present invention is suitably applicable to solar cells, organic EL elements, and the like.

### EXPLANATION OF REFERENCES

10: (gas) barrier film

12, 12a, 12b, 12c, 12d: support

14: underlying organic layer

16: inorganic layer

18: intermediate organic layer

19: protective organic layer

20: organic film forming apparatus

24: inorganic film forming apparatus

26: coating unit

28: drying unit

30: light irradiation unit

32, 56: rotary shaft

34, 58: roll-up shaft

36, 38: pair of transportation rollers

42, 42b, 42d, 46a, 46c: material roll

48, 73: supply roll

49, 70: collection roll

50: supply chamber

52: film formation chamber

54: roll-up chamber

60, 68, 72, 80: pass roller

61, 74, 82: vacuum exhaust means

62: drum

64: film formation means

76, 78: partition wall

76a, 78a: opening

Ga, Gb: protective film

What is claimed is:

1. A gas barrier film comprising:
two or more combinations of an inorganic layer and an organic layer which becomes an underlying base of the inorganic layer on one surface of a support,
wherein in a case where the organic layer is provided on a surface of the support, the organic layer on the surface of the support is an underlying organic layer, and the organic layer between the inorganic layers is an intermediate organic layer, a thickness of the intermediate organic layer is 0.05 to 0.5 μm, and a ratio between the thickness of the intermediate organic layer and a thickness of the underlying organic layer is 0.1 or less, and
the intermediate organic layer contains a polymer of (meth)acrylate represented by Formula (1), 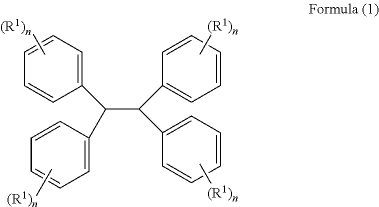
in Formula (1), R^{I}'s each represent a substituent and may be the same or different from each other; and n's each represent an integer of 0 to 5 and may be the same or different from each other, where at least one R¹ includes (meth)acryloyl group.

2. The gas barrier film according to claim 1,
wherein the intermediate organic layer contains a polymer of urethane (meth)acrylate.

3. The gas barrier film according to claim 2,
wherein the urethane (meth)acrylate is hexafunctional or higher functional urethane (meth)acrylate.

4. The gas barrier film according to claim 1,
wherein the intermediate organic layer contains a polymer of (meth)acrylate having a double bond equivalent of 200 or less.

5. The gas barrier film according to claim 1,
wherein the (meth)acrylate represented by Formula (1) is tetrafunctional or higher functional (meth)acrylate.

6. A method of producing a gas barrier film comprising:
alternately forming an organic layer and an inorganic layer on one surface of a support such that two or more layers of the organic layers and two or more layers of the inorganic layers are formed,
wherein in a case where the organic layer is formed on a surface of the support, an organic layer which is formed on the surface of the support is an underlying organic layer, and an organic layer which is formed between the inorganic layers is an intermediate organic layer, the underlying organic layer and the intermediate organic layer are formed such that a thickness of the intermediate organic layer is 0.05 to 0.5 μm, and a ratio between the thickness of the intermediate organic layer and a thickness of the underlying organic layer is 0.1 or less, and,
the intermediate organic layer is formed by performing a coating step of applying a polymerizable composition containing (meth)acrylate represented by Formula (1) to the inorganic layer, a drying step of heating and drying the polymerizable composition applied to the inorganic layer, and a curing step of curing the dried polymerizable composition, 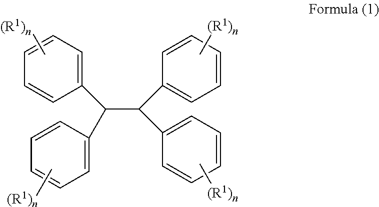
in Formula (1), R¹'s each represent a substituent and may be the same or different from each other; and n's each represent an integer of 0 to 5 and may be the same or different from each other, where at least one R¹ includes (meth)acryloyl group.

7. The method of producing a gas barrier film according to claim 6,
wherein the polymerizable composition contains urethane (meth)acrylate.

8. The method of producing a gas barrier film according to claim 7,
wherein the urethane (meth)acrylate is hexafunctional or higher functional urethane (meth)acrylate.

9. The method of producing a gas barrier film according to claim 6,
wherein the polymerizable composition contains polyfunctional (meth)acrylate having a double bond equivalent of 200 or less.

10. The method of producing a gas barrier film according to claim 6,
wherein the (meth)acrylate represented by Formula (1) is tetrafunctional or higher functional (meth)acrylate.

11. The method of producing a gas barrier film according to claim 6,
wherein the inorganic layer and the organic layer are formed by a roll to roll method,
after the inorganic layer is formed and before the formed inorganic layer is brought into contact with another member, a protective film is laminated on a surface of the inorganic layer, and,
before the intermediate organic layer is formed, the protective film is peeled off from the inorganic layer, and before the inorganic layer is brought into contact with the other member, the coating step is performed.

12. The method of producing a gas barrier film according to claim 11,
wherein the protective film is formed of polyolefin.

13. The method of producing a gas barrier film according to claim 6,
wherein a viscosity of the polymerizable composition is 1 Pa·s or more.
